(19) United States
(12) Patent Application Publication
(10) Pub. No.: US 2014/0222771 A1
(43) Pub. Date: Aug. 7, 2014

(54) MANAGEMENT DEVICE AND MANAGEMENT METHOD

(71) Applicant: FUJITSU LIMITED, Kawasaki-shi (JP)

(72) Inventors: Atsuji SEKIGUCHI, Kawasaki (JP); Kuniaki Shimada, Kawasaki (JP); Yuji Wada, Ota (JP); Akiko Matsumoto, Yokohama (JP); Akio Oba, Kawasaki-shi (JP); Ryouji Yoshimi, Kawasaki (JP)

(73) Assignee: FUJITSU LIMITED, Kawasaki-shi (JP)

(21) Appl. No.: 14/249,758

(22) Filed: Apr. 10, 2014

Related U.S. Application Data
(63) Continuation of application No. PCT/JP2011/073729, filed on Oct. 14, 2011.

(51) Int. Cl. G06F 17/30

(52) U.S. Cl. CPC G06F 17/30082
USPC 707/694

(57) ABSTRACT

A management device includes a memory and a processor coupled to the memory. The processor executes a process including: acquiring, from a plurality of devices, group information indicating a management group used to manage the devices and setting information indicating a setting item and setting content that are set in each of the devices; extracting a setting item corresponding to setting content that is common to devices included in a same management group indicated by the acquired group information; and creating, for the extracted setting item, a rule indicating that a common setting content is set to the devices included in the same management group.

### CROSS-REFERENCE TO RELATED APPLICATION

This application is a continuation of International Application No. PCT/JP2011/073729, filed on Oct. 14, 2011, and designating the U.S., the entire contents of which are incorporated herein by reference.

### FIELD

The embodiments discussed herein are directed to a management device and a management method.

### BACKGROUND

In recent years, due to an increase in the number of various devices, such as servers, network devices, storage devices, and the like, in systems, there is a need for reducing the number of setting items or setting errors performed by, for example, system administrators who set the various devices. An example of such systems includes a large scale information and communication technology (ICT) system used in a cloud service provider.

When setting information on devices common to a group, such as the location where the devices are installed, an administrator, or the like, is changed, there is a conventional device that changes setting information on multiple devices by changing, using a predetermined inheritance tree, some setting information.

Patent Document 1: Japanese Laid-open Patent Publication No. 2004-118371

However, with the conventional device described above, there is a problem in that setting information on devices is still not able to be easily managed.

Specifically, with the conventional device, a developer or an administrator of the devices grasps setting information on each of the devices and then creates an inheritance tree. Consequently, a large number of man-hours are needed for creating the inheritance tree. Thus, with the conventional device described above, it is difficult to easily manage setting information on the devices. Furthermore, with the conventional device described above, there is also a problem in that, because a developer or an administrator creates an inheritance tree, an error occurs in the content of the inheritance tree.

### SUMMARY

According to an aspect of an embodiment, a management device includes a memory and a processor coupled to the memory. The processor executes a process including: acquiring, from a plurality of devices, group information indicating a management group used to manage the devices and setting information indicating a setting item and setting content that are set in each of the devices; extracting a setting item corresponding to setting content that is common to devices included in a same management group indicated by the acquired group information; and creating, for the extracted setting item, a rule indicating that a common setting content is set to the devices included in the same management group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a system configuration to which a management device according to a first embodiment is applied;

FIG. 2 is a schematic diagram illustrating an example of the functional configuration of the management device according to the first embodiment;

FIG. 3 is a schematic diagram illustrating an example of setting information;

FIG. 4 is a schematic diagram illustrating an example of a rule classification table;

FIG. 5 is a schematic diagram illustrating an example of a tree structure;

FIG. 6 is a schematic diagram illustrating an example of setting content allocated to the tree structure;

FIG. 7 is a schematic diagram illustrating an example of setting content allocated to the tree structure;

FIG. 8 is a schematic diagram illustrating an example of setting content allocated to the tree structure;

FIG. 9 is a schematic diagram illustrating an example of setting content allocated to the tree structure;

FIG. 10 is a schematic diagram for an explanation of the tree structure;

FIG. 11 is a schematic diagram illustrating an example of a process performed by the management device according to the first embodiment;

FIG. 12 is a schematic diagram illustrating an example of a process performed by the management device according to the first embodiment;

FIG. 13 is a schematic diagram illustrating an example of a process performed by the management device according to the first embodiment;

FIG. 14 is a schematic diagram illustrating an example of a process performed by the management device according to the first embodiment;

FIG. 15 is a schematic diagram illustrating an example of a process performed by the management device according to the first embodiment;

FIG. 16 is a schematic diagram illustrating an example of a process in which setting content of a new server is set in setting information when the rule type of the selected setting item is “all common” and “group common”;

FIG. 17 is a schematic diagram illustrating an example of a process performed by the management device according to the first embodiment;

FIG. 18 is a schematic diagram illustrating an example of a process performed by the management device according to the first embodiment;

FIG. 19 is a schematic diagram illustrating an example of setting information in which setting content of a new server is set by the management device according to the first embodiment;

FIG. 20 is a schematic diagram illustrating an example of a screen displayed on a displaying unit according to the first embodiment;

FIG. 21 is a schematic diagram illustrating an example of a displayed message indicating that editing content does not conform to the existing rule;

FIG. 22 is a schematic diagram illustrating an example of another screen displayed on a displaying unit according to the first embodiment;

FIG. 23 is a flowchart illustrating the flow of a first management process according to the first embodiment;

FIG. 24 is a flowchart illustrating the flow of a rule extracting process according to the first embodiment;

FIG. 25 is a flowchart illustrating the flow of the rule extracting process according to the first embodiment;

FIG. 26 is a flowchart illustrating the flow of a tree structure creating process according to the first embodiment;

FIG. 27 is a flowchart illustrating the flow of a setting information creating process according to the first embodiment;

FIG. 28 is a flowchart illustrating the flow of a second management process according to the first embodiment;

FIG. 29 is a flowchart illustrating the flow of the second management process according to the first embodiment;

FIG. 30 is a flowchart illustrating the flow of a third management process according to the first embodiment;

FIG. 31 is a flowchart illustrating the flow of the third management process according to the first embodiment; and

FIG. 32 is a block diagram illustrating a computer that executes a management program.

### DESCRIPTION OF EMBODIMENTS

Preferred embodiments of the present invention will be explained with reference to accompanying drawings. The embodiments do not limit the disclosed technology. Furthermore, the embodiments can be appropriately used in combination as long as the processes do not conflict with each other.

### [a] First Embodiment

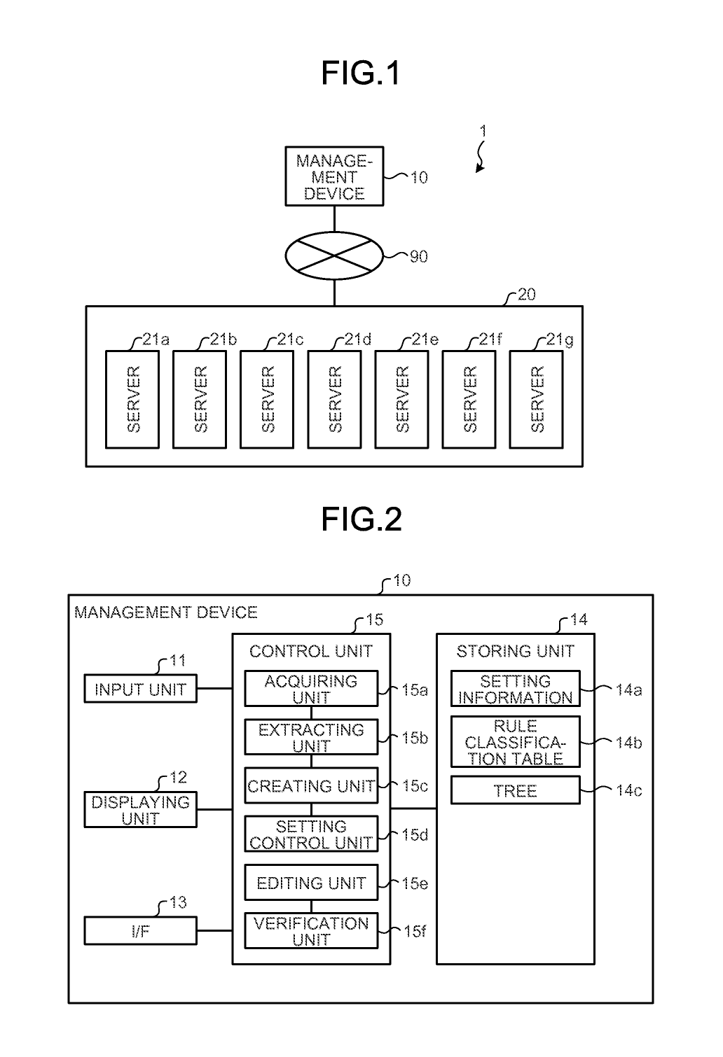

A management device according to a first embodiment will be described. FIG. 1 is a schematic diagram illustrating an example of a system configuration to which a management device according to a first embodiment is applied. In the example illustrated in FIG. 1, a system 1 includes a management device 10 and a management target system 20. The management device 10 and the management target system 20 can communicate with each other via a network 90. An example of the management target system 20 includes an ICT system used in a cloud service provider. The management target system 20 includes various devices, such as servers, network devices, storage devices, and the like. Setting information that is set in each of the devices in the management target system 20 is to be managed by the management device 10. The setting information is set in, for example, a setting item of a file on each device. In the example illustrated in FIG. 1, the management target system 20 includes seven servers 21a to 21g. In a description below, the description will be given with the assumption that, when six servers 21a to 21f out of the seven servers 21a to 21g are running, the single server 21g is newly added into the management target system 20.

The management device 10 acquires setting information from each of the six servers 21a to 21f. Then, the management device 10 extracts, from the acquired setting information, a setting rule for the setting information and then creates a setting rule for setting information. Subsequently, on the basis of the created rule, the management device 10 creates setting information on the new server 21g that is newly added. Then, the management device 10 delivers the created setting information to the server 21g and allows the server 21g to set the setting information. As described above, on the basis of the setting information acquired from each of the existing six servers 21a to 21f, the management device 10 creates a rule that is used when setting information is set in the server 21g. Accordingly, with the management device 10, because a rule that is used when setting information that is set in the server 21g is created by a process, the setting information on a device can be easily managed when compared with a case in which a person creates a rule. Furthermore, it is possible to reduce an amount of a process that extracts a setting target having the same setting content. Furthermore, with the management device 10, because the rule is created on the basis of the setting information acquired from the existing servers 21a to 21f, the rule can be created in a precise manner from an actual environment in which the existing servers 21a to 21f is stably running.

Functional Configuration of the Management Device

FIG. 2 is a schematic diagram illustrating an example of the functional configuration of the management device according to the first embodiment. As illustrated in FIG. 2, the management device 10 includes an input unit 11, a displaying unit 12, an interface (I/F) 13, a storing unit 14, and a control unit 15.

The input unit 11 inputs various kinds of information to the control unit 15. For example, the input unit 11 receives, from a user, an instruction to perform a first management process, a second management process, and a third management process, which will be described later, and then inputs the received instruction to the control unit 15. Furthermore, the input unit 11 receives, from a user, an ID that is used to specify a group and then inputs the received instruction to the control unit 15. An example device of the input unit 11 includes an operation reception device, such as a mouse or a keyboard.

The displaying unit 12 displays various kinds of information. For example, the displaying unit 12 displays, by using an editing unit 15e, which will be described later, a screen used for editing. An example device of the displaying unit 12 includes a liquid crystal display.

The I/F 13 is used for communication between the devices. For example, the control unit 15 in the management device 10 and the servers 21a to 21g are connected to the I/F 13 via the network 90. Consequently, the management device 10 and the servers 21a to 21g can communicate with each other.

The storing unit 14 stores therein various kinds of information. For example, the storing unit 14 stores therein setting information 14a, a rule classification table 14b, and a tree 14c.

The setting information 14a indicates the setting information that is set in each of the devices. In the setting information 14a, setting information is registered by an acquiring unit 15a and a creating unit 15c, which will be described later. The setting information 14a is displayed on the displaying unit 12. Consequently, an administrator or the like can grasp the setting information that is set in each of the devices.

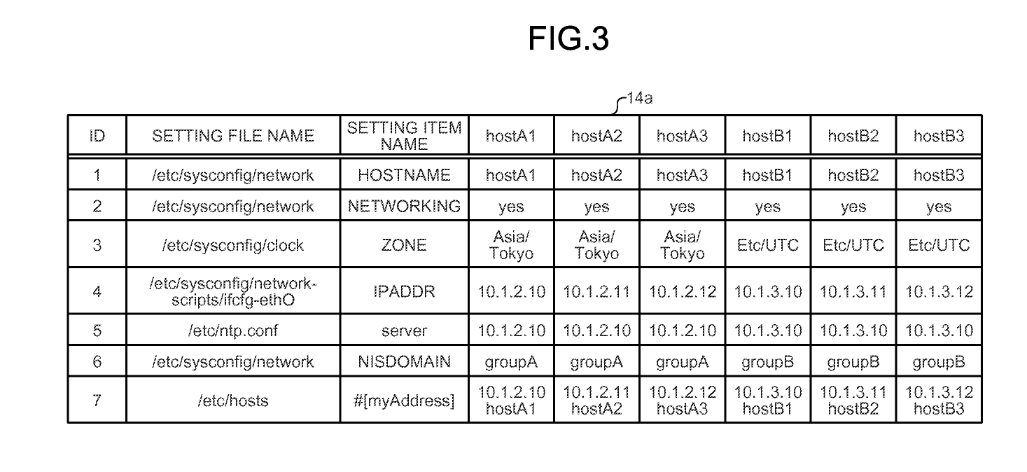

FIG. 3 is a schematic diagram illustrating an example of setting information. In the example illustrated in FIG. 3, the setting information 14a includes items of the identification (ID) that is used to identify a setting item, the setting item name, and the setting information that is set in each of the six servers 21a to 21f. FIG. 3 illustrates an example of a case in which the server names of the six servers 21a to 21f are “hostA1”, “hostA2”, “hostA3”, “hostB1”, “hostB2”, and “hostB3”, respectively. The server name mentioned here is the name of a server that is used to uniquely identify the server. FIG. 3 illustrates an example of a case in which, in the file in the folder of “/etc/sysconfig” in the server 21a with the server name of “hostA1”, the following setting content is set. Namely, FIG. 3 illustrates an example of a case in which “hostA1” is set in the setting item of the file with the file name of “network” and in the setting item of the setting item name of “HOSTNAME”. Furthermore, a server name is set in the setting item of the setting item name of “HOSTNAME”.

FIG. 3 illustrates an example of a case in which, in the file in the folder of “/etc/sysconfig” in the server 21a with the server name of “hostA1”, the following setting content is set. Namely, FIG. 3 illustrates an example of a case in which “yes” is set in the setting item of the file with the file name of “network” and in the setting item of the setting item name of “NETWORKING”. Furthermore, in the setting item of the setting item name of “NETWORKING”, “yes” is set if a network is used, whereas “no” is set if a network is not used.

Furthermore, FIG. 3 illustrates an example of a case in which, in the file in the folder of “/etc/sysconfig” in the server 21a with the server name of “hostA1”, the following setting content is set. Namely, FIG. 3 illustrates an example of a case in which “Asia/Tokyo” is set in the setting item of the file with the file name of “clock” and in the setting item of the setting item name of “ZONE”. Furthermore, in the setting item of the setting item name of “ZONE”, a region that is a reference of the time is set.

Furthermore, FIG. 3 illustrates an example of a case in which, in the file in the folder of “/etc/sysconfig/network-scripts” in the server 21a with the server name of “hostA1”, the following setting content is set. Namely, FIG. 3 illustrates an example of a case in which “10.1.2.10” is set in the setting item of the file with the file name of “ifcfg-eth0” and in the setting item of the setting item name of “IPADDR”. Furthermore, the Internet Protocol (IP) address of the server is set in the setting item of the setting item name of “IPADDR”.

Furthermore, FIG. 3 illustrates an example of a case in which, in the file in the folder of “/etc” in the server 21a with the server name of “hostA1”, the following setting content is set. Namely, FIG. 3 illustrates an example of a case in which “10.1.2.10” is set in the setting item of the file with the file name of “ntp.conf” and in the setting item of the setting item name of “server”. Furthermore, the IP address of the time synchronization server that is used to synchronize the time is registered in the setting item of the setting item name of “server”.

Furthermore, FIG. 3 illustrates an example of a case in which, in the file in the folder of “/etc/sysconfig” in the server 21a with the server name of “hostA1”, the following setting content is set. Namely, FIG. 3 illustrates an example of a case in which “groupA” is set in the setting item of the file with the file name of “network” and in the setting item of the setting item name of “NISDOMAIN”. Furthermore, the group name of a network to which a server belongs is set in the setting item of the setting item name of “NISDOMAIN”.

Furthermore, FIG. 3 illustrates an example of a case in which, in the file in the folder of “/etc” in the server 21a with the server name of “hostA1”, the following setting content is set. Namely, FIG. 3 illustrates an example of a case in which “10.1.2.10” and “hostA1” are set in the setting item of the file with the file name of “hosts”. Furthermore, because no setting item name is present for this setting item, FIG. 3 illustrates an example of a case in which the variable #[myAddress] is registered in the item of the setting item name. Namely, the variable #[myAddress] indicates both the IP address and the host name of the server.

Furthermore, FIG. 3 illustrates an example of a case in which, in the file in the folder of “/etc/sysconfig” in the server 21d with the server name of “hostB1”, the following setting content is set. Namely, FIG. 3 illustrates an example of a case in which “hostB1” is set in the setting item of the file with the file name of “network” and in the setting item of the setting item name of “HOSTNAME”.

Furthermore, FIG. 3 illustrates an example of a case in which, in the file in the folder of “/etc/sysconfig” in the server 21d with the server name of the “hostB1”, the following setting content is set. Namely, FIG. 3 illustrates an example of a case in which “yes” is set in the setting item of the file with the file name of “network” and in the setting item of the setting item name of “NETWORKING”.

Furthermore, FIG. 3 illustrates an example of a case in which, in the file in the folder of “/etc/sysconfig” in the server 21d with the server name of “hostB1”, the following setting content is set. Namely, FIG. 3 illustrates an example of a case in which “Etc/UTC” is set in the setting item of the file with the file name of “clock” and in the setting item of the setting item name of “ZONE”.

Furthermore, FIG. 3 illustrates an example of a case in which, in the file in the folder of “/etc/sysconfig/network-scripts” in the server 21d with the server name of the “hostB1”, the following setting content is set. Namely, FIG. 3 illustrates an example of a case in which “10.1.3.10” is set in the setting item of the file with the file name of “ifcfg-eth0” and in the setting item of the setting item name of “IPADDR”.

Furthermore, FIG. 3 illustrates an example of a case in which, in the file in the folder of “/etc” in the server 21d with the server name of “hostB1”, the following setting content is set. Namely, FIG. 3 illustrates an example of a case in which “10.1.3.10” is set in the setting item of the file with the file name of “ntp.conf” and in the setting item of the setting item name of “server”.

Furthermore, FIG. 3 illustrates an example of a case in which, in the file in the folder of “/etc/sysconfig” in the server 21d with the server name of “hostB1, the following setting content is set. Namely, FIG. 3 illustrates an example of a case in which “groupB” is set in the setting item of the file with the file name of “network” and in the setting item of the setting item name of “NISDOMAIN”.

Furthermore, FIG. 3 illustrates an example of a case in which, in the file in the folder of “/etc” in the server 21d with the server name of “hostB1”, the following setting content is set. Namely, FIG. 3 illustrates an example of a case in which “10.1.3.10” and “hostB1” are set in the setting item of the file with the file name of “hosts”.

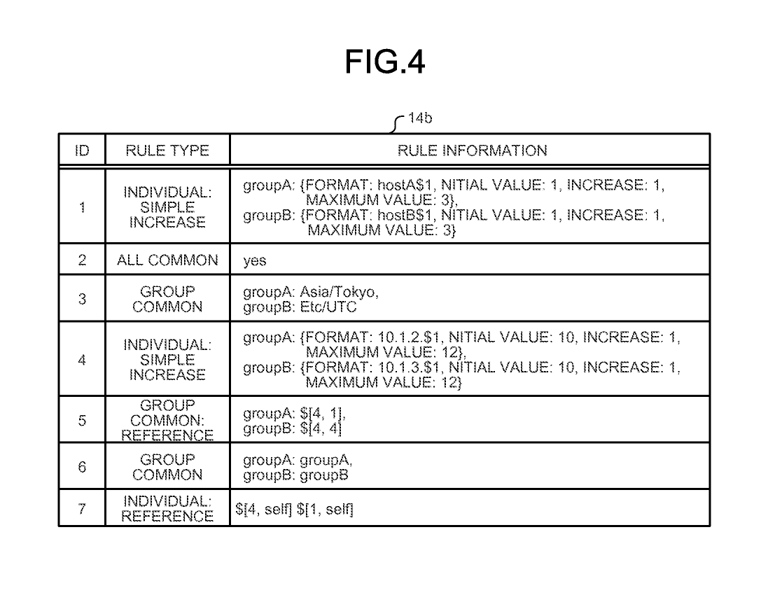

In the rule classification table 14b, the rule type that is obtained by classifying the setting items is registered by the creating unit 15c, which will be described later. FIG. 4 is a schematic diagram illustrating an example of a rule classification table. In the example illustrated in FIG. 4, the rule classification table 14b includes items of the ID that is used to identify a setting item, the rule type, and the rule information. In the example illustrated in FIG. 4, if setting content varies for each server, if a value is contained in the setting content, and if the value has the predetermined regularity, for example, if the value is simply increased, “individual:simple increase” is registered in the item of the rule type. Furthermore, in the example illustrated in FIG. 4, in such a case, information that indicates the predetermined regularity is registered in the item of the rule information. In the following, a specific example will be described. It is assumed that, as in the example illustrated in FIG. 3, the host name of the servers 21a to 21c belonging to “groupA” that is set in the setting item associated with the ID of “1”, i.e., that is set in the setting item of the setting item name of “HOSTNAME”, is as follows. Namely, it is assumed that the host name of the servers 21a to 21c, i.e., the value subsequent to the “hostA”, increases by “1” starting from the initial value “1” to the maximum value “3” in this way: “hostA1”, “hostA2”, and “hostA3”. In this case, as in the example illustrated in FIG. 4, “hostA$1” is registered in an associated manner with “groupA” in the item of the rule information. In the example illustrated in FIG. 4, “$1” in “hostA$1” is a variable and increases by “1” starting from the initial value “1” to the maximum value “3”.

Furthermore, it is assumed that, as in the example illustrated in FIG. 3, the host name of the servers 21d to 21f belonging to “groupB” that is set in the setting item associated with the ID of “1” is as follows. Namely, it is assumed that the value subsequent to the host name of the servers 21d to 21f, i.e., the value subsequent to the “hostB”, increases by “1” starting from the initial value “1” to the maximum value “3” in this way: “hostB1”, “hostB2”, and “hostB3”. In this case, as in the example illustrated in FIG. 4, “hostB$1” is registered in an associated manner with “groupB” in the item of the rule information. In the example illustrated in FIG. 4, “$1” in “hostB$1” is a variable and increases by “1” starting from the initial value “1” to the maximum value “3”.

Furthermore, it is assumed that, as in the example illustrated in FIG. 3, the IP address of the servers 21a to 21c belonging to “groupA” that is set in the setting item associated with the ID of “4”, i.e., that is set in the setting item of the setting item name of “IPADDR”, is as follows. Namely, it is assumed that the IP address of the servers 21a to 21c, i.e., the value subsequent to “10.1.2.” increases by “1” starting from the initial value “10” to the maximum value “12” in this way: “10.1.2.10”, “10.1.2.11”, and “10.1.2.12”. In this case, as in the example illustrated in FIG. 4, “10.1.2.$1” is registered in an associated manner with “groupA” in the item of the rule information. In the example illustrated in FIG. 4, “$1” in “10.1.2.$1” is a variable and increases by “1” starting from the initial value “10” to the maximum value “12”.

Furthermore, it is assumed that, as in the example illustrated in FIG. 3, the IP address of the servers 21d to 21f belonging to “groupB” that is set in the setting item associated with the ID “4”, i.e., that is set in the setting item of the setting item name of “IPADDR”, is as follows. Namely, it is assumed that the IP address of the servers 21d to 21f, i.e., the value subsequent to “10.1.3.” increases by “1” starting from the initial value “10” to the maximum value “12” in this way: “10.1.3.10”, “10.1.3.11”, and “10.1.3.12”. In this case, as in the example illustrated in FIG. 4, “10.1.3.$1” is registered in an associated manner with “groupB” in the item of the rule information. In the example illustrated in FIG. 4, “$1” in “10.1.3.$1” is a variable and increases by “1” starting from the initial value “10” to the maximum value “12”.

Furthermore, in the example illustrated in FIG. 4, if setting content is the same in all of the servers, “all common” is registered in the item of the rule type. Furthermore, in the example illustrated in FIG. 4, in such a case, the same setting content is registered in the item of the rule information stored in all of the servers. In the following, a specific example will be described. It is assumed that, as in the example illustrated in FIG. 3, the same setting content “yes” is set in the setting item associated with the ID “2”, i.e., the setting item of the setting item name “NETWORKING” in all of the servers 21a to 21f. In such a case, “all common” is registered in the item of the rule type and the setting content of “yes” is registered in the item of the rule information in the rule classification table 14b.

Furthermore, in the example illustrated in FIG. 4, if setting content is the same in a group and if some of the setting content does not refer to another setting content, i.e., if some of the setting content does not include another setting content, “group common” is registered in the item of the rule type. Furthermore, in the example illustrated in FIG. 4, in such a case, setting content is registered, for each group, in the item of the rule information. In the following, a specific example will be described. It is assumed that, as in the example illustrated in FIG. 3, for the setting item associated with the ID “3”, i.e., for the setting item of the setting item name of “ZONE”, “Asia/Tokyo” is set in the servers 21a to 21c in “groupA” and “Etc/UTC” is set in the servers 21d to 21f in “groupB”. In such a case, “group common” is registered in the item of the rule type in the rule classification table 14b; “Asia/Tokyo” is registered in an associated manner with “groupA” in the item of the rule information; and “Etc/UTC” is registered in an associated manner with “groupB” in the item of the rule information.

Furthermore, in the example illustrated in FIG. 4, if setting content is the same in a group and if some of the setting content can be obtained by referring to another setting content, i.e., if some of the setting content includes another setting content, “group common:reference” is registered in the item of the rule type. Furthermore, in the example illustrated in FIG. 4, in such a case, information that indicates a reference target is registered, for each group, in the item of the rule information. In the following, a specific example will be described. It is assumed that, as in the example illustrated in FIG. 3, for the setting item associated with the ID “5”, i.e., for the setting item of the setting item name of “server”, “10.1.2.10” that is obtained by referring to the content registered in the “1^{st}” column of the record with the ID of “4” is set for “groupA”. In such a case, in the rule classification table 14b, “group common:reference” is registered in the item of the rule type and “$[4,1]” is registered in an associated manner with “groupA” in the item of the rule information. In the example illustrated in FIG. 4, $[4,1] indicates that the setting content that is registered in the “1^{st}” column of the record with the ID of “4” in the setting information 14a is used as the reference target. Furthermore, it is assumed that, as in the example illustrated in FIG. 3, for the setting item associated with the ID “5”, i.e., for the setting item of the setting item name of “server”, “10.1.3.10” that is obtained by referring to the content registered in a “4^{th}” column of the record with the ID of “4” is set for “groupB”. In such a case, in the rule classification table 14b, “group common:reference” is registered in the item of the rule type and “$[4,4]” is registered in an associated manner with “groupB” in the item of the rule information. In the example illustrated in FIG. 4, $[4,4] indicates that the setting content that is registered in the “4^{th}” column of the record with the ID of “4” in the setting information 14a is used as the reference target.

Furthermore, in the example illustrated in FIG. 4, if the setting content varies for each server and if some of the setting content can be obtained by referring to another setting content, “individual:reference” is registered in the item of the rule type. Furthermore, in the example illustrated in FIG. 4, in such a case, information that indicates a reference target is registered, for each server, in the item of the rule information. A specific example will be described below.

It is assumed that, as in the example illustrated in FIG. 3, the IP address and the host name of each server is set in the variable #[myAddress] that is associated with the ID “7”. Because the setting item of the setting item name in which the setting content is set is not present, in the embodiment, the variable #[myAddress] is registered in the item of the setting item name. Furthermore, in the example illustrated in FIG. 3, the IP address, which is obtained by referring to the content registered in the record with the ID of “4”, and the host name, which is obtained by referring to the content registered in the record with the ID of “1”, are set, for each server, in the variable #[myAddress]. In such a case, in the rule classification table 14b, “individual:reference” is set in the item of the rule type and “$[4,self]$[1,self]” is registered in the item of the rule information. In the example illustrated in FIG. 4, from among pieces of the setting content registered in the record with the ID of “4” in the setting information 14a, $[4,self] indicates that the setting content that is associated with the target device is used as the reference target. Furthermore, in the example illustrated in FIG. 4, from among pieces of the setting content registered in the record with the ID of “1” in the setting information 14a, $[1,self] indicates that the setting content that is associated with the target device is used as the reference target. For example, in the example illustrated in FIG. 4, in a case of the server 21a, “$[4,self]$[1,self]” indicates that “10.1.2.10”, which is associated with the server 21a related to the record with the ID of “4”, and “hostA1”, which is associated with the server 21a related to the record with the ID of “1”, are used as the reference target.

Furthermore, in the example illustrated in FIG. 4, in a case of the server 21b, “$[4,self]$[1,self]” indicates that “10.1.2.11”, which is associated with the server 21b related to the record with the ID of “4”, and “hostA2”, which is associated with the server 21b related to the record with the ID of “1”, are used as the reference target. Furthermore, in the example illustrated in FIG. 4, in a case of the server 21c, “$[4,self]$[1,self]” indicates that “10.1.2.12”, which is associated with the server 21c related to the record with the ID of “4”, and “hostA3”, which is associated with the server 21c in the record with the ID of “1”, are used as the reference target. Furthermore, in the example illustrated in FIG. 4, in a case of the server 21d, “$[4,self]$[1,self]” indicates that “10.1.3.10”, which is associated with the server 21d related to the record with the ID of “4”, and “hostB1”, which is associated with the server 21d related to the record with the ID of “1”, are used as the reference target. Furthermore, in the example illustrated in FIG. 4, in a case of the server 21e, “$[4,self]$[1,self]” indicates that “10.1.3.11”, which is associated with the server 21e related to the record with the ID of “4”, and “hostB2”, which is associated with the server 21e related to the record with the ID of “1”, are used as the reference target. Furthermore, in the example illustrated in FIG. 4, in a case of the server 21f, “$[4,self]$[1,self]” indicates that “10.1.3.12”, which is associated with the server 21f related to the record with the ID of “4”, and “hostB3”, which is associated with the server 21f related to the record with the ID of “1”, are used as the reference target.

Furthermore, if setting content varies for each server and if a value is not included in setting content, or, even if a value is included in setting content, if the value does not have predetermined regularity and some of the setting content does not refer to another setting content, the following content is registered in the rule classification table 14b. Namely, “individual” is set in the item of the rule type. In such a case, because no rule is present, no data is registered in the item of the rule information.

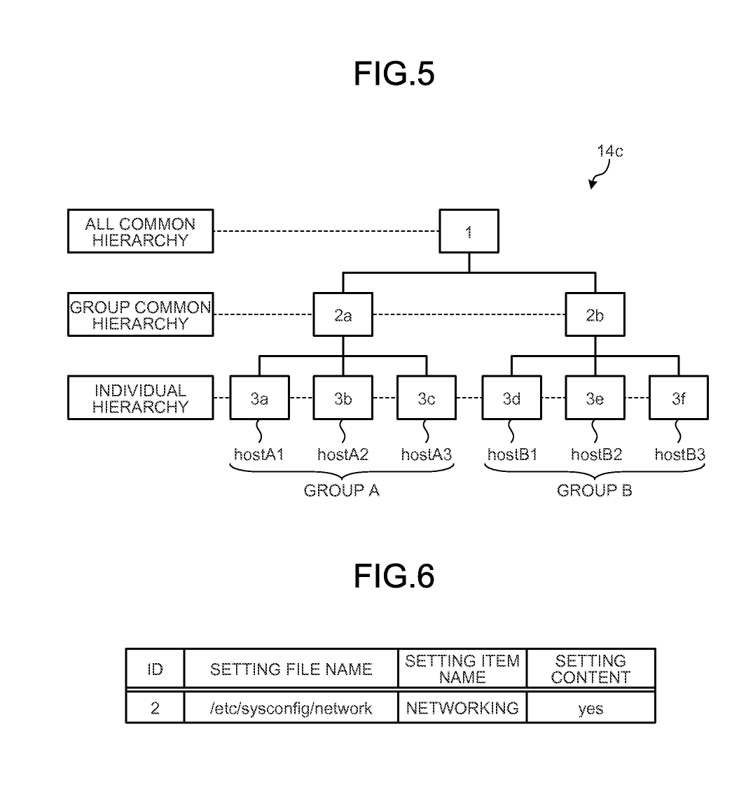

The tree 14c has a hierarchy in accordance with the rule type. In the hierarchy included in the tree 14c, the setting content of a setting item of the rule type classified by the rule classification table 14b is allocated by the creating unit 15c, which will be described later. FIG. 5 is a schematic diagram illustrating an example of a tree structure. In the example illustrated in FIG. 5, the setting content of “all common”, which is the rule type in the rule classification table 14b, is allocated to the all common hierarchy of “1”. FIG. 6 is a schematic diagram illustrating an example of setting content allocated to the tree structure. The example in FIG. 6 illustrates the setting content that is related to the hierarchy “1” illustrated in the example in FIG. 5, that is associated with the ID of “2” related to the rule type of “all common” in the example illustrated in FIG. 4, and that is stored in the setting information 14a.

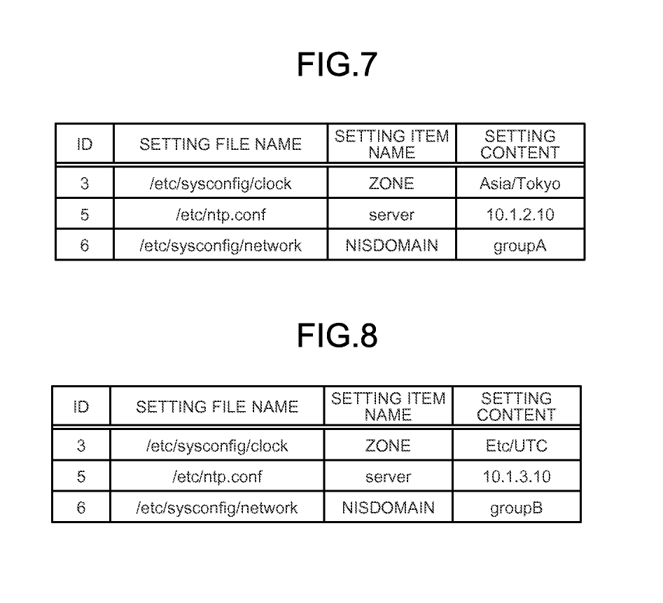

Furthermore, in the example illustrated in FIG. 5, from among pieces of the setting content in the rule types of “group common” and the “group common:reference” in the rule classification table 14b, the setting content that is associated with “groupA” is allocated to the group common hierarchy of “2a”. FIG. 7 is a schematic diagram illustrating an example of setting content allocated to the tree structure. The example in FIG. 7 illustrates the setting content that is allocated to the hierarchy “2a” illustrated in the example in FIG. 5, and that is associated with “groupA” in the setting information 14a corresponding to the ID of “3” related to the “group common” in the rule type in the example illustrated in FIG. 4. Furthermore, the example in FIG. 7 illustrates the setting content that is allocated to the hierarchy “2a” illustrated in the example in FIG. 5, and that is associated with “groupA” in the setting information 14a corresponding to the ID of “5” related to the “group common:reference” in the rule type in the example illustrated in FIG. 4. Furthermore, the example in FIG. 7 illustrates the setting content that is allocated to the hierarchy “2a” illustrated in the example in FIG. 5, and that is associated with “groupA” in the setting information 14a corresponding to the ID of “6” related to the “group common” in the rule type in the example illustrated in FIG. 4.

Furthermore, in the example illustrated in FIG. 5, from among pieces of the setting content in the rule types of “group common” and the “group common:reference” in the rule classification table 14b, the setting content that is associated with “groupB” is allocated to the group common hierarchy of “2b”. FIG. 8 is a schematic diagram illustrating an example of setting content allocated to the tree structure. The example in FIG. 8 illustrates the setting content that is allocated to the hierarchy “2b” illustrated in the example in FIG. 5, and that is associated with “groupB” in the setting information 14a corresponding to the ID of “3” related to the “group common” in the rule type in the example illustrated in FIG. 4. Furthermore the example in FIG. 8 illustrates the setting content that is allocated to the hierarchy “2b” illustrated in the example in FIG. 5, and that is associated with “groupB” in the setting information 14a corresponding to the ID of “5” related to the “group common:reference” in the rule type in the example illustrated in FIG. 4. Furthermore the example in FIG. 8 illustrates the setting content that is allocated to the hierarchy “2b” illustrated in the example in FIG. 5, and that is associated with “groupB” in the setting information 14a corresponding to the ID of “6” related to the “group common” in the rule type in the example illustrated in FIG. 4.

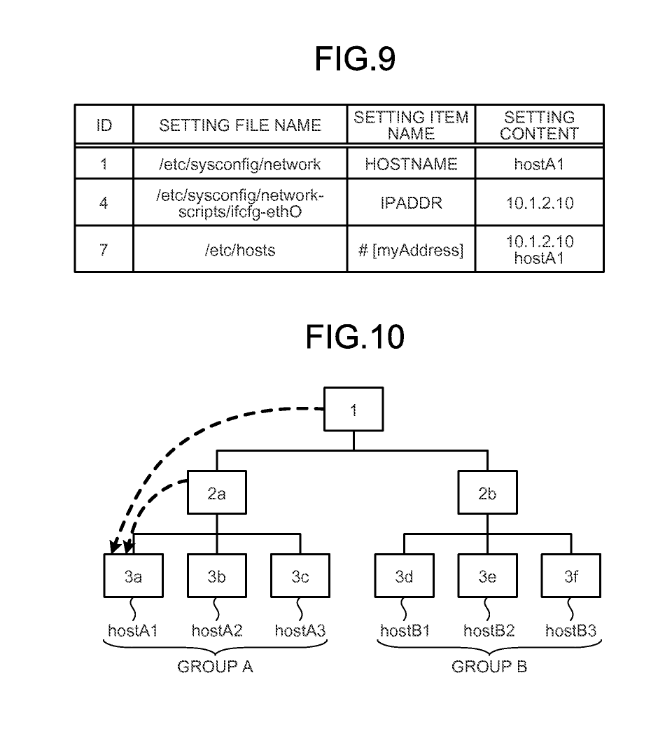

Furthermore, in the example illustrated in FIG. 5, from among pieces of the setting content in the rule types of “individual:simple increase” and the “individual:reference” in the rule classification table 14b, the setting content associated with the server 21a with the host name of “hostA1” is allocated to the individual hierarchy “3a”. FIG. 9 is a schematic diagram illustrating an example of setting content allocated to the tree structure. The example in FIG. 9 illustrates the setting content that is allocated to the hierarchy “3a” illustrated in the example in FIG. 5, and that is associated with “hostA1” in the setting information 14a corresponding to the ID of “1” related to the “individual:simple increase” in the rule type in the example illustrated in FIG. 4. Furthermore, the example in FIG. 9 illustrates the setting content that is allocated to the hierarchy “3a” illustrated in the example in FIG. 5, and that is associated with “hostA1” in the setting information 14a corresponding to the ID of “4” related to the “individual:simple increase” in the rule type in the example illustrated in FIG. 4. Furthermore, the example in FIG. 9 illustrates the setting content that is allocated to the hierarchy “3a” illustrated in the example in FIG. 5, and that is associated with “hostA1” in the setting information 14a corresponding to the ID of “7” related to the “individual:reference” in the rule type in the example illustrated in FIG. 4.

Furthermore, in the example illustrated in FIG. 5, from among pieces of the setting content in the rule types of “individual:simple increase” and the “individual:reference” in the rule classification table 14b, the setting content associated with the server 21b with the host name of “hostA2” is allocated to an individual hierarchy “3b”. Furthermore, in the example illustrated in FIG. 5, from among pieces of the setting content in the rule types of “individual:simple increase” and the “individual:reference” in the rule classification table 14b, the setting content that is associated with the server 21c with the host name of “hostA3” is allocated to the individual hierarchy “3c”. Furthermore, in the example illustrated in FIG. 5, from among pieces of the setting content in the rule types of “individual:simple increase” and the “individual:reference” in the rule classification table 14b, the setting content that is associated with the server 21d with the host name of “hostB1” is allocated to the individual hierarchy “3d”. Furthermore, in the example illustrated in FIG. 5, from among pieces of the setting content in the rule types of “individual:simple increase” and the “individual:reference” in the rule classification table 14b, the setting content associated with the server 21e with the host name of “hostB2” is allocated to the individual hierarchy “3e”. Furthermore, in the example illustrated in FIG. 5, from among pieces of the setting content in the rule types of “individual:simple increase” and the “individual:reference” in the rule classification table 14b, the setting content associated with the server 21f with the host name of “hostB3” is allocated to the individual hierarchy “3f”.

FIG. 10 is a schematic diagram for an explanation of the tree structure. As illustrated in FIG. 10, from among the setting items of the server 21a with the host name of “hostA1”, for the setting item of higher level hierarchies “2a” and “1”, the setting contents of these higher level hierarchies “2a” and “1” are referred. Consequently, the setting item of the server 21a with the host name of “hostA1” can be changed by simply changing the setting content of the setting item of these hierarchies “2a” and “1”. Thus, the number of man-hours or setting errors can be reduced.

The storing unit 14 is, for example, a semiconductor memory device, such as a flash memory, or a storage device, such as a hard disk, an optical disk, or the like. However, the storing unit 14 is not limited to the type of storage device mentioned above. For example, a random access memory (RAM) or a read only memory (ROM) may also be used.

The control unit 15 includes an internal memory that stores therein control data and programs that prescribe various kinds of procedures, whereby various kinds of processes are executed. As illustrated in FIG. 2, the control unit 15 includes the acquiring unit 15a, an extracting unit 15b, the creating unit 15c, a setting control unit 15d, the editing unit 15e, and a verification unit 15f.

The acquiring unit 15a acquires, from multiple devices, group information that indicates a management group that is used to manage the multiple devices and setting information that indicates the setting item and the setting content that are set in the multiple devices.

A specific example will be described below. If an instruction to execute a first management process is received from a user via the input unit 11, the acquiring unit 15a sends, to the servers 21a to 21f, an instruction to send, to the management device, the setting information indicating a setting item and setting content that are set in each of the servers. Consequently, the setting information indicating the setting item and the setting content is sent from the servers 21a to 21f to the management device and then the acquiring unit 15a acquires the received setting information. Then, the acquiring unit 15a registers, in the setting information 14a, the setting information received from the servers 21a to 21f. As illustrated in FIG. 3, the setting content for each setting item that is set in each of the servers 21a to 21f is registered in the setting information 14a. Then, the acquiring unit 15a acquires the setting information 14a from the storing unit 14 and allows the displaying unit 12 to display the acquired setting information 14a. Consequently, an administrator of the management device 10 can determine, from the content of the setting information 14a displayed on the displaying unit 12, the ID of the group to be specified.

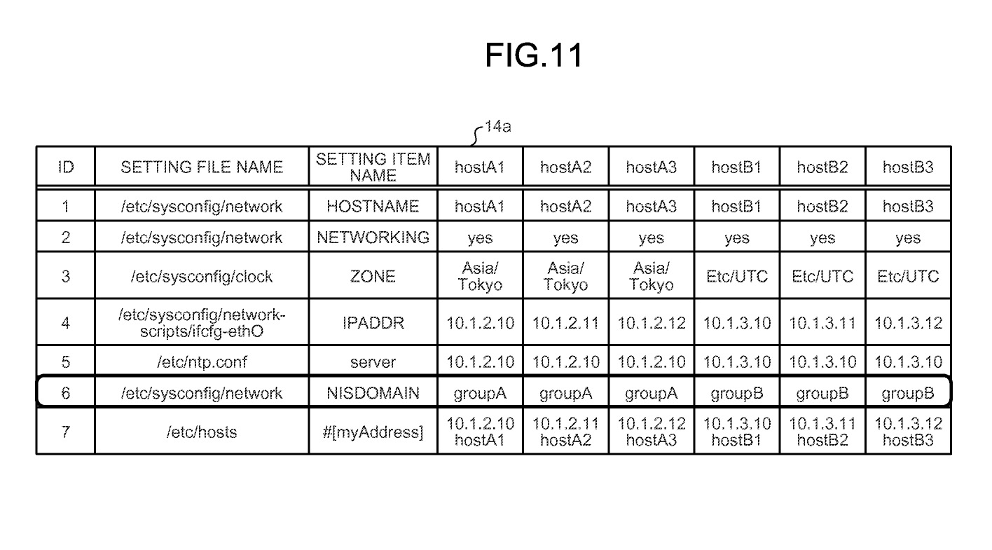

Then, the acquiring unit 15a acquires, from the input unit 11, the ID of the group to be specified. This ID is input by a user. FIG. 11 is a schematic diagram illustrating an example of a process performed by the management device according to the first embodiment. FIG. 11 illustrates a case in which a user inputs “6” as the ID of the group to be specified. In the example illustrated in FIG. 11, the acquiring unit 15a acquires “6” as the ID of the group to be specified.

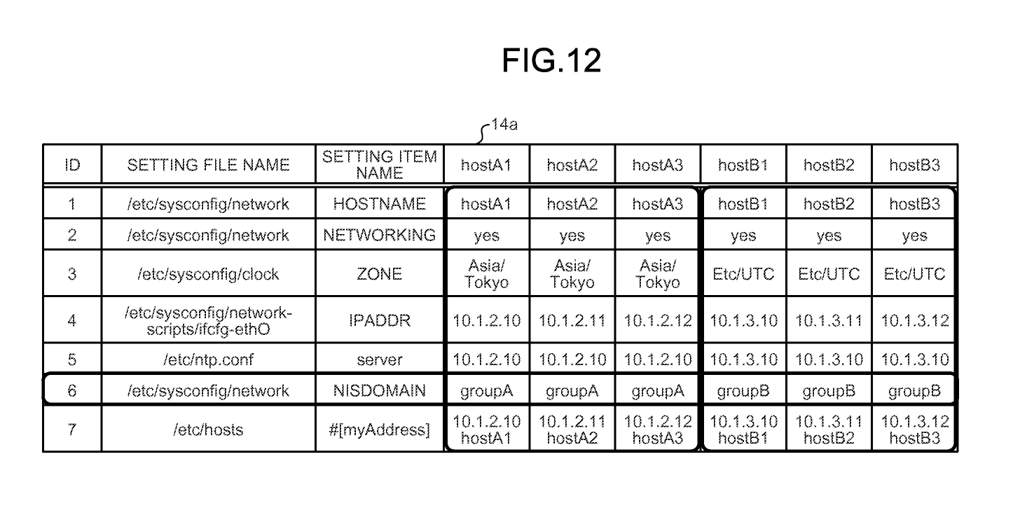

Then, the acquiring unit 15a acquires a group. For example, the acquiring unit 15a specifies, from the setting content that is set in the setting item indicated by the acquired ID, the server belonging to each group. FIG. 12 is a schematic diagram illustrating an example of a process performed by the management device according to the first embodiment. In the example illustrated in FIG. 12, the acquiring unit 15a specifies that the servers 21a to 21c belong to “groupA” and specifies that the servers 21d to 21f belong to “groupB”. The “groupA” and “groupB” are groups in a network and are groups that indicate the management groups that are used to manage the servers 21d to 21f.

The extracting unit 15b extracts, from among the multiple devices, a setting item having the same setting content in each of the devices in the management groups indicated by the group information that is acquired by the acquiring unit 15a. Furthermore, the extracting unit 15b extracts, from among the multiple devices, a setting item having the predetermined regularity of the setting content in each of the devices in the management groups indicated by the group information that is acquired by the acquiring unit 15a.

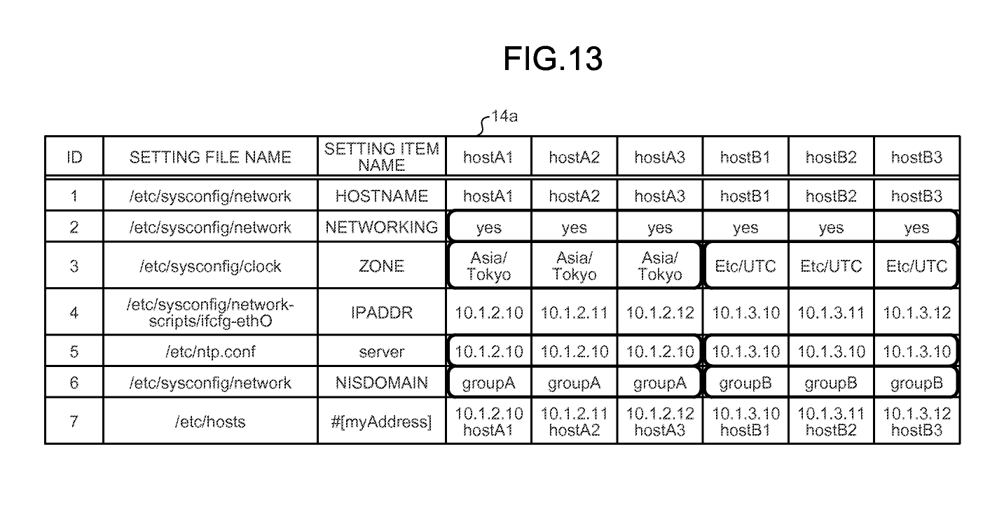

A specific example will be described below. The extracting unit 15b performs the following process on all of the records registered in the setting information 14a, i.e., all of the setting items. Namely, first, the extracting unit 15b selects one record that has not been selected before. Then, the extracting unit 15b determines whether all of the setting content in the servers 21a to 21f registered in the selected record is the same. FIG. 13 is a schematic diagram illustrating an example of a process performed by the management device according to the first embodiment. The example illustrated in FIG. 13 indicates a case in which “yes” is registered, as the setting content in each of the servers 21a to 21f, in the record with the ID of “2”. Consequently, in the example illustrated in FIG. 13, if the extracting unit 15b selects the record with the ID of “2”, the extracting unit 15b determines that the setting content in the servers 21a to 21f registered in the selected record are all the same.

If the determination result indicates that all of the setting content is the same, the extracting unit 15b extracts the ID and the setting content of the selected record. In the example illustrated in FIG. 13, the extracting unit 15b extracts the ID of “2” and the setting content of “yes”.

In contrast, if the determination result indicates that not all of the setting content is the same, the extracting unit 15b determines whether some of the setting content in the selected record does not refer to another setting content and determines whether all of the setting content in the group that is specified by the acquiring unit 15a is the same. The example illustrated in FIG. 13 indicates a case in which “Asia/Tokyo” is registered, in the record with the ID of “3”, as the setting content of the servers 21a to 21c in “groupA”. Furthermore, the example illustrated in FIG. 13 indicates a case in which “Etc/UTC” is registered, in the record with the ID of “3”, as the setting content of the servers 21d to 21f in “groupB”. Furthermore, the example illustrated in FIG. 13 indicates a case in which “groupA” is registered, in the record with the ID of “6”, as the setting content of the servers 21a to 21c in “groupA”. Furthermore, the example illustrated in FIG. 13 indicates a case in which “groupB” is registered, in the record with the ID of “6”, as the setting content of the servers 21d to 21f in “groupB”. Furthermore, in the example illustrated in FIG. 13, the setting content of the servers 21a to 21f registered in the records with the IDs of “3” and “6” do not refer to another setting content. Consequently, in the example illustrated in FIG. 13, if the extracting unit 15b selects the records with the IDs of “3” and “6”, the extracting unit 15b determines that some of the setting content in the selected record does not refer to another setting content and determines that all of the setting content in the group that is specified by the acquiring unit 15a is the same.

If the determination result indicates that some of the setting content in the selected record does not refer to another setting content and indicates that all of the setting content in the group that is specified by the acquiring unit 15a is the same, the extracting unit 15b extracts the ID of the selected record and the setting content for each group. In the example illustrated in FIG. 13, the extracting unit 15b extracts the ID of “3”, the setting content of “Asia/Tokyo” in “groupA”, and the setting content of “Etc/UTC” in “groupB”. Furthermore, in the example illustrated in FIG. 13, the extracting unit 15b extracts the ID of “6”, the setting content of “groupA” stored in “groupA”, and the setting content of “groupB” stored in “groupB”.

In contrast, if the determination result indicates that some of the setting content in the selected record can be obtained by referring to another setting content or indicates that not all of the setting content in the group specified by the acquiring unit 15a is the same, the extracting unit 15b performs the following process. Namely, the extracting unit 15b determines whether some of the setting content can be obtained by referring to another setting content and determines whether all of the setting content in a group is the same. The example illustrated in FIG. 13 indicates a case in which “10.2.1.10” is registered in the record with the ID of “5”, as the setting content of the servers 21a to 21c in “groupA”. Furthermore, the example illustrated in FIG. 13 indicates a case in which “10.1.3.10” is registered in the record with the ID of “5”, as the setting content of the servers 21d to 21f in “groupB”. Furthermore, in the example illustrated in FIG. 13, the setting content of the servers 21a to 21c that is registered in the record with the ID of “5” can be obtained by referring to the setting content in the “1^{st}” column of the record with the ID of “4”. Furthermore, in the example illustrated in FIG. 13, the setting content of the servers 21d to 21f registered in the record with the ID of “5” can be obtained by referring to the setting content in the “4^{th}” column of the record with the ID of “4”. Consequently, in the example illustrated in FIG. 13, if the extracting unit 15b selects the record with the ID of “5”, the extracting unit 15b determines that some of the setting content can be obtained by referring to another setting content and determines that all of the setting content in a group specified by the acquiring unit 15a is the same.

If the determination result indicates that some of the setting content in the selected record can be obtained by referring to another setting content and indicates that the setting content is the same in the group specified by the acquiring unit 15a, the extracting unit 15b extracts the ID of the selected record and information that indicates the reference target for each group. In the example illustrated in FIG. 13, the extracting unit 15b extracts the ID of “5” and the reference target of $[4,1] in “groupA”. Furthermore, in the example illustrated in FIG. 13, the extracting unit 15b extracts the ID of “5” and the reference target of $[4,4] in “groupB”.

In contrast, if the determination result indicates that some of the setting content in the selected record does not refer to another setting content or indicates that not all of the setting content in the group specified by the acquiring unit 15a is the same, the extracting unit 15b performs the following process. Namely, the extracting unit 15b determines whether all of the setting content of the servers in the selected record differs and determines whether some of the setting content can be obtained by referring to another setting content. The example illustrated in FIG. 13 indicates a case in which “10.1.2.10, hostA1”, “10.1.2.11, hostA2”, and “10.1.2.12, hostA3” are registered in the record with the ID of “7” as the setting content of the servers 21a to 21c, respectively, in “groupA”. Furthermore, the example illustrated in FIG. 13 indicates a case in which “10.1.3.10, hostB1”, “10.1.3.11, hostB2”, and “10.1.3.12, hostB3” are registered in the record with the ID of “7” as the setting content of the servers 21d to 21f, respectively, in “groupB”. Furthermore, in the example illustrated in FIG. 13, the setting content of the servers 21a to 21c registered in the record with the ID of “7” can be obtained by referring to the setting content of the target device in the record with the ID of “4” and referring to the setting content of the target device in the record with the ID of “1”. Furthermore, in the example illustrated in FIG. 13, the setting content of the servers 21d to 21f registered in the record with the ID of “7” can be obtained by referring to the setting content of the target device in the record with the ID of “4” and referring to the setting content of the target device in the record with the ID of “1”. Consequently, in the example illustrated in FIG. 3, when the extracting unit 15b selects the record with the ID of “7”, the extracting unit 15b determines that all of the setting content of the servers in the selected record differs and determines that some of the setting content can be obtained by referring to another setting content.

If the determination result indicates that all of the setting content of the servers in the selected record differs and some of the setting content can be obtained by referring to another setting content, the extracting unit 15b extracts the ID of the selected record and the information that indicates the reference target for each server. In the example illustrated in FIG. 3, the extracting unit 15b extracts the ID of “7” and the reference target of “$[4,self]$[1,self]” for each server.

In contrast, if the determination result indicates that not all of the setting content of the servers in the selected record differs or some of the setting content is not able to be obtained by referring to the other setting content, the extracting unit 15b performs the following process. Namely, the extracting unit 15b determines whether all of the setting content of the servers in the selected record differs and the setting content has the predetermined regularity. An example of the predetermined regularity mentioned here includes the regularity in which a value is included in each piece of the setting content and the value increases by a predetermined value. In the following, a description will be given of a case in which, as the regularity described above, a value is included in each piece of the setting content and the value increases by a predetermined value; however, the regularity is not limited to this. A value that decreases by a predetermined value may also be used or letters of the alphabet that are included in the setting content and that are sorted in the alphabetical order may also be used.

In the example illustrated in FIG. 3, for the setting content of the servers 21a to 21c registered in the record with the ID of “1”, the value subsequent to “hostA” increases by “1” starting from the initial value “1” to the maximum value “3” in this way: “hostA1”, “hostA2”, and “hostA3”. Furthermore, in the example illustrated in FIG. 3, for the setting content of the servers 21d to 21f registered in the record with the ID of “1”, the value subsequent to “hostB” increases by “1” starting from the initial value “1” to the maximum value “3” in this way: “hostB1”, “hostB2”, and “hostB3”. Furthermore, in the example illustrated in FIG. 3, the setting content of the servers 21a to 21c registered in the record with the ID of “4” is “10.1.2.10”, “10.1.2.11”, and “10.1.2.12”, respectively. Specifically, in the example illustrated in FIG. 3, the value subsequent to “10.1.2.” increases by “1” starting from the initial value “10” to the maximum value “12”. Furthermore, in the example illustrated in FIG. 3, the setting content of the servers 21d to 21f registered in the record with the ID of “4” is “10.1.3.10”, “10.1.3.11”, and “10.1.3.12”, respectively. Specifically, in the example illustrated in FIG. 3, the value subsequent to “10.1.3.” increases by “1” starting from the initial value “10” to the maximum value “12”.

Consequently, in the example illustrated in FIG. 3, when the extracting unit 15b selects the records with the IDs of “1” and “4”, the extracting unit 15b determines that all of the setting content of the servers in the selected record differs and determines that the setting content has the predetermined regularity.

If the determination result indicates that all of the setting content of the servers in the selected record differs and indicates that the setting content has the predetermined regularity, the extracting unit 15b extracts the ID of the selected record and the information that indicates the simple increase regularity for each server. In the example illustrated in FIG. 3, the extracting unit 15b extracts the ID of “1”; extracts the regularity of “hostA$1, initial value:1, increment 1, and maximum value 3” for each server; and extracts the regularity of “hostB$1, initial value:1, increment 1, and maximum value 3” for each server. Furthermore, in the example illustrated in FIG. 3, the extracting unit 15b extracts the ID of “4”; extracts the regularity of “10.1.2.$1, initial value:10, increment 1, and maximum value 12” for each group; and extracts the regularity of “10.1.3.$1, initial value:10, increment 1, and maximum value 12” for each group.

Furthermore, if no positive determination is obtained in the determination described above, it is assumed that the determination result indicates that all of the setting content of the servers in the selected record differs, indicates that no predetermined regularity is present in the setting content, and indicates that some of the setting content is not able to obtain by referring to the other setting content. An example of such setting content includes a value that simply differs in each server, such as a media access control (MAC) address of hardware in each server. Accordingly, if the record in which this type of setting content is registered is selected, the extracting unit 15b extracts the ID of the selected record. The extracting unit 15b performs the process described above on all of the records registered in the setting information 14a, i.e., all of the setting item.

For the setting item extracted by the extracting unit 15b, the creating unit 15c creates a rule indicating that setting content associated with a setting item is set, in common, in the devices included in the same management group. Furthermore, for the setting item having the predetermined regularity extracted by the extracting unit 15b, the creating unit 15c creates a rule indicating that setting is performed, on the basis of the predetermined regularity, on the devices included in the same management group.

A specific example will be described below. If the extracting unit 15b determines that all of the setting content of the servers 21a to 21f registered in the selected record is the same, the creating unit 15c performs the following process. Namely, the creating unit 15c associates the rule type “all common” with the ID and the setting content extracted by the extracting unit 15b and then registers them in the items of the rule type, the ID, and the rule information in the rule classification table 14b. By doing so, a rule is created. In the example illustrated in FIG. 13, the creating unit 15c registers the information indicating “all common”, the ID of “2”, and the setting content of “yes” in the items of the rule type, the ID, and the rule information, respectively, in the rule classification table 14b, as illustrated in FIG. 4.

Furthermore, if the extracting unit 15b determines that some of the setting content in the selected record does not refer to the other setting content and the setting content is the same in a group, the creating unit 15c performs the following process. Namely, the creating unit 15c associates the rule type “group common” with the ID and the setting content for each group extracted by the extracting unit 15b and then registers them in the items of the rule type, the ID, and the rule information in the rule classification table 14b. By doing so, a rule is created. In the example illustrated in FIG. 13, the creating unit 15c registers the information indicating “group common”, the ID of “3”, and the setting content of “Asia/Tokyo” stored in “groupA” and “Etc/UTC” stored in “groupB” in the items of the rule type, the ID, and the rule information, respectively, in the rule classification table 14b. Furthermore, in the example illustrated in FIG. 13, the creating unit 15c registers the information indicating “group common”, the ID of “6”, and the setting content of “groupA” stored in “groupA” and “groupB” stored in “groupB” in the items of the rule type, the ID, and the rule information in the rule classification table 14b, respectively, as illustrated in FIG. 4.

Furthermore, if the extracting unit 15b determines that some of the setting content in the selected record can be obtained by referring to the other setting content and the setting content is the same in a group, the creating unit 15c performs the following process. Namely, the creating unit 15c associates the rule type of “group common:reference” with the ID and the information indicating the reference target for each group that are extracted by the extracting unit 15b and then registers them in the items of the rule type, the ID, and the rule information in the rule classification table 14b. By doing so, a rule is created. In the example illustrated in FIG. 13, the creating unit 15c registers the information indicating “group common:reference”, the ID of “5”, and the information “$[4,1]” and “$[4,4]” indicating the reference target of “groupA” and “groupB”, respectively, in the items of the rule type, the ID, and the rule information, respectively, as illustrated in FIG. 4.

Furthermore, if the extracting unit 15b determines that all of the setting content of the servers in the selected record differs and some of the setting content can be obtained by referring to the other setting content, the creating unit 15c performs the following process. Namely, the creating unit 15c associates the rule type of “individual:reference” with the ID and the information indicating the reference target that are extracted by the extracting unit 15b and then registers them in the items of the rule type, the ID, and the rule information in the rule classification table 14b. In the example illustrated in FIG. 3, the creating unit 15c registers the information indicating “individual:reference”, the ID of “7”, and both the information “$[4,1]” indicating the reference target and the reference target of “$[4,self]$[1,self]” stored in “groupB” in the items of the rule type, the ID, and the rule information in the rule classification table 14b, respectively, as illustrated in FIG. 4.

Furthermore, if the extracting unit 15b determines that all of the setting content of the servers in the selected record differs and the setting content has the predetermined regularity, the creating unit 15c performs the following process. Namely, the creating unit 15c associates the rule type “individual:simple increase” with the ID and the information indicating the regularity that are extracted by the extracting unit 15b and then registers them in the items of the rule type, the ID, and the rule information in the rule classification table 14b. By doing so, a rule is created. In the example illustrated in FIG. 3, the creating unit 15c registers the information indicating “individual:simple increase”, the ID of “1”, the information “hostA$1, initial value:1, increment 1, and maximum value 3” indicating the regularity in the items of the rule type, the ID, and the rule information, respectively, as illustrated in FIG. 4. Furthermore, in the example illustrated in FIG. 3, the creating unit 15c registers the information indicating “individual:simple increase”, the ID of “1”, the information “hostB$1, initial value:1, increment 1, and maximum value 3” indicating the regularity in the item of the rule type, item, and the rule information, respectively, as illustrated in FIG. 4. Furthermore, in the example illustrated in FIG. 3, the creating unit 15c registers information indicating “individual:simple increase”, the ID of “4”, and the information “10.1.2.$1, initial value:10, increment 1, and maximum value 12” indicating the regularity in the items of the rule type, the ID, and the rule information, respectively, as illustrated in FIG. 4. Furthermore, in the example illustrated in FIG. 3, the creating unit 15c registers the information indicating the “individual:simple increase”, the ID of “4”, the information “10.1.3.$1, initial value:10, increment 1, and maximum value 12” indicating the regularity in the items of the rule type, the ID, and the rule information, respectively, as illustrated in FIG. 4.

Furthermore, if the extracting unit 15b determines that all of the setting content of the servers in the selected record differs, determines that the setting content does not have the predetermined regularity, and determines that some of the setting content is not able to obtain by referring to the other setting content, the creating unit 15c performs the following process. Namely, the creating unit 15c associates the rule type of “individual” with the ID extracted by the extracting unit 15b and then registers them in the items of the rule type and the ID, respectively in the rule classification table 14b.

Furthermore, the creating unit 15c creates the setting information 14a. In the following, a description will be given of a case of creating the setting information 14a in which the setting content that is set in the server 21g belonging to the “groupB” in the network, which is specified by a user, is newly added. In this example, the host name of the server 21g is “hostB4”. A specific example will be described below. First, the creating unit 15c reads the rule classification table 14b created by the process described above from the storing unit 14. Then, the creating unit 15c determines, from among the records in the rule classification table 14b, whether a record that has not been selected is present. If records that have not been selected are present, the creating unit 15c selects one record that has not been selected. Then, the creating unit 15c determines whether the rule type of the selected record is “all common”. If the rule type of the selected record is “all common”, the creating unit 15c searches the setting information 14a for a record with the same ID number as that of the selected record. Then, the creating unit 15c allocates the setting content indicated by the record that is obtained from the searched result to the hierarchy named “all common” in the tree 14c. For example, in the example illustrated in FIG. 13, the creating unit 15c allocates the setting content illustrated in the example in FIG. 6 to the hierarchy named all common in the tree 14c.

Furthermore, the creating unit 15c determines whether the rule type of the selected record is “group common” or “group common:reference”. The rule type of the selected record is “group common” or “group common:reference”, the creating unit 15c searches the setting information 14a for a record with the same ID number as that of the selected record. Then, the creating unit 15c allocates the setting content indicated by the record that is obtained from the searched result to the hierarchy named “group common” in the tree 14c. For example, in the example illustrated in FIG. 13, the creating unit 15c allocates the setting content illustrated in the examples in FIGS. 7 and 8 to the hierarchy named “group common” in the tree 14c.

Furthermore, if the rule type of the selected record is “individual:simple increase” or “individual:reference”, the creating unit 15c searches the setting information 14a for a record with the same ID number as that of the selected record. Then, the creating unit 15c allocates the setting content indicated by the record that is obtained from the searched result to the hierarchy named individual in the tree 14c. For example, in the example illustrated in FIG. 13, the creating unit 15c allocates the setting content illustrated in the example in FIG. 9 to the hierarchy named “individual” in the tree 14c.

The creating unit 15c repeatedly the process described above until all records in the rule classification table 14b have been selected. Consequently, the setting content is allocated to each of the hierarchies in the tree 14c.

Then, the creating unit 15c sends, to the new server 21g, an instruction to send the set setting item to the management device 10. Consequently, the creating unit 15c can specify, from the setting item sent from the server 21g, a setting item of the server 21g. Subsequently, the creating unit 15c specifies, from the rule classification table 14b, each of the rule types of the setting items of the server 21g. Then, from among the setting items of the server 21g with the rule type of “all common”, “group common”, and “group common:reference”, the creating unit 15c selects one setting item that has not been selected. Then, the creating unit 15c determines whether the rule type of the selected setting item is “group common:reference”.

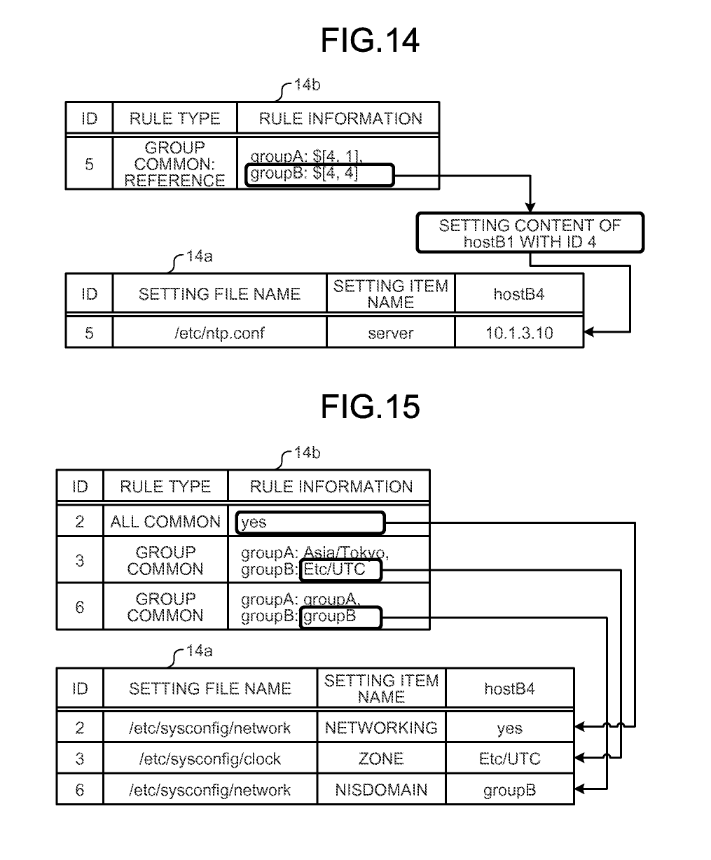

If the rule type of the selected setting item is “group common:reference”, the creating unit 15c acquires, from the rule classification table 14b, the information indicating the reference target that is associated with the selected setting item. FIG. 14 is a schematic diagram illustrating an example of a process performed by the management device according to the first embodiment. FIG. 14 illustrates an example of a part of the rule classification table 14b and an example of a part of the setting information 14a. Furthermore, FIG. 14 schematically illustrates a case in which setting information on the server 21g is set in the setting information 14a on the basis of the rule classification table 14b. The example illustrated in FIG. 14 indicates a case in which, because the group of the network to which the server 21g belongs is “groupB”, the creating unit 15c acquires, from the rule classification table 14b, the reference target of “$[4,4]” associated with “groupB”. Then, by using the information indicating the acquired reference target, the creating unit 15c acquires the setting content of the reference target from the setting information 14a. The example illustrated in FIG. 14 indicates a case in which the creating unit 15c acquires, from the setting information 14a by using the reference target “$[4,4]”, the setting content “10.1.3.10” of the server 21d with the host name of “hostB1” in the record with the ID of “4”. Subsequently, the creating unit 15c sets the acquired setting content in the corresponding item in the setting information 14a. The “corresponding item” mentioned here means the selected setting item. The example illustrated in FIG. 14 indicates a case in which “10.1.3.10” is set in the item of the server 21g in the record with the ID of “5”.

Furthermore, if the rule type of the selected setting item is not “group common:reference”, i.e., if the rule type of the selected setting item is “all common” or “group common”, the creating unit 15c acquires the setting content associated with the selected setting item from the rule information in the rule classification table 14b. FIG. 15 is a schematic diagram illustrating an example of a process performed by the management device according to the first embodiment. The example illustrated in FIG. 15 indicates a case in which, if the setting item indicated by the ID of “2” is selected, the creating unit 15c acquires “yes” from the rule information in the rule classification table 14b. Furthermore, the example illustrated in FIG. 15 indicates a case in which, if the creating unit 15c selects the setting item indicated by the ID of “3”, the creating unit 15c acquires “Etc/UTC” from the rule information in the rule classification table 14b. Furthermore, the example illustrated in FIG. 15 indicates a case in which, if the creating unit 15c selects the setting item indicated by the ID of “6”, the creating unit 15c acquires the “groupB” from the rule information in the rule classification table 14b. Then, the creating unit 15c sets the acquired setting content in the corresponding item in the setting information 14a. The example illustrated in FIG. 15 indicates a case in which “yes” is set in the item of the server 21g in the record with the ID of “2”. Furthermore, the example illustrated in FIG. 15 indicates a case in which “Etc/UTC” is set in the item of the server 21g in the record with the ID of “3”. Furthermore, the example illustrated in FIG. 15 indicates a case in which “groupB” is set in the item of the server 21g in the record with the ID of “6”.

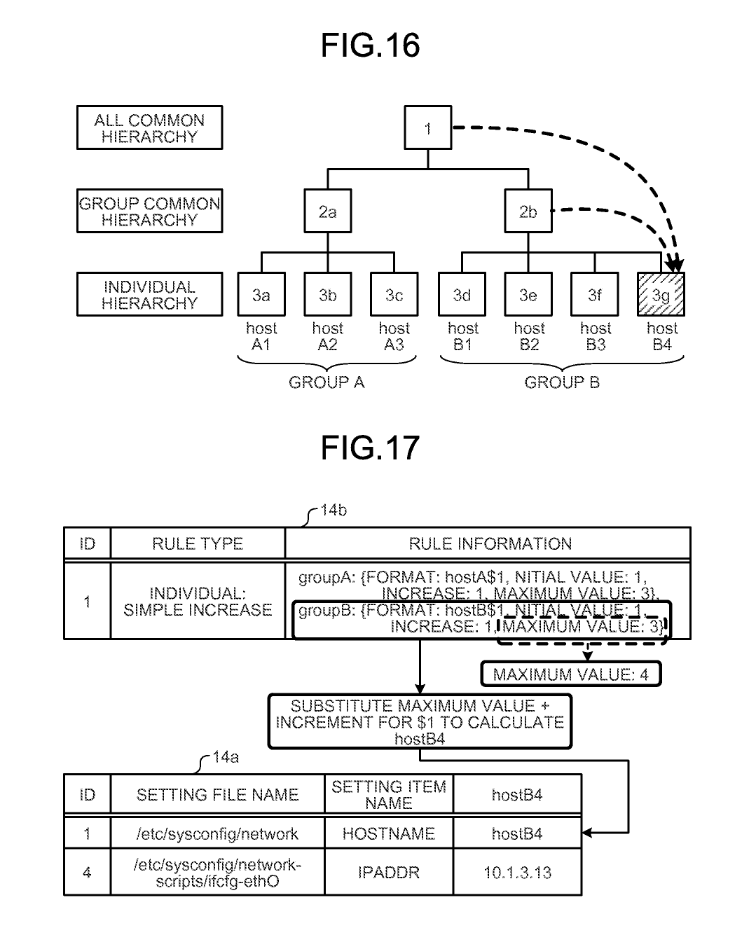

A description will be given of an example of a process that, if the rule type of the setting item that is selected by using the tree 14c is “all common” or “group common”, the setting content of the server 21g is set in the setting information 14a. FIG. 16 is a schematic diagram illustrating an example of a process in which setting content of a new server is set in setting information when the rule type of the selected setting item is “all common” or “group common”. The example illustrated in FIG. 16 indicates a case in which the setting content allocated in the higher level hierarchies “1” and “2b” of the server 21g is set, as the setting content of the server 21g, in the setting information 14a.

The creating unit 15c repeatedly performs the process described above until no setting item that has not been selected is present in the setting item of the server 21g related to “all common”, “group common”, and “group common:reference”.

Furthermore, the creating unit 15c selects one setting item that has not been selected from among the setting items of the server 21g with the rule types of “individual:simple increase”, “individual:reference”, and “individual”. Then, the creating unit 15c determines whether the rule type of the selected setting item is “individual:simple increase”.

If the rule type of the selected setting item is “individual:simple increase”, the creating unit 15c acquires, from the rule classification table 14b, the information indicating the regularity that is associated with the selected setting item. FIG. 17 is a schematic diagram illustrating an example of a process performed by the management device according to the first embodiment. FIG. 17 illustrates an example of a part of the rule classification table 14b and an example of a part of the setting information 14a. Furthermore, FIG. 17 schematically illustrates a case in which setting information related to the server 21g is set in the setting information 14a on the basis of the rule classification table 14b. The example illustrated in FIG. 17 indicates a case in which the creating unit 15c acquires, from the rule classification table 14b, the information “hostB$1, initial value:1, increment 1, and maximum value 3” indicating the regularity that is associated with “groupB”. Then, the creating unit 15c calculates setting content by using the information that indicates the acquired regularity. For example, in the example illustrated in FIG. 17, the creating unit 15c calculates the value “4” by adding the increment “1” to the maximum value “3” and then calculates the setting content of “hostB4” by substituting the calculated value “4” for “$1”. At this point, the creating unit 15c changes the maximum value of the information that indicates the regularity associated with “groupB” to “4”.

Then, the creating unit 15c sets the calculated setting content in the corresponding item in the setting information 14a. The example illustrated in FIG. 17 indicates a case in which “hostB4” is set in the item of the server 21g in the record with the ID of “1”.

In contrast, if the rule type of the selected setting item is not “individual:simple increase”, i.e., if the rule type of the selected setting item is “individual:reference” or “individual”, the creating unit 15c determines whether the rule type of the selected setting item is “individual:reference”.

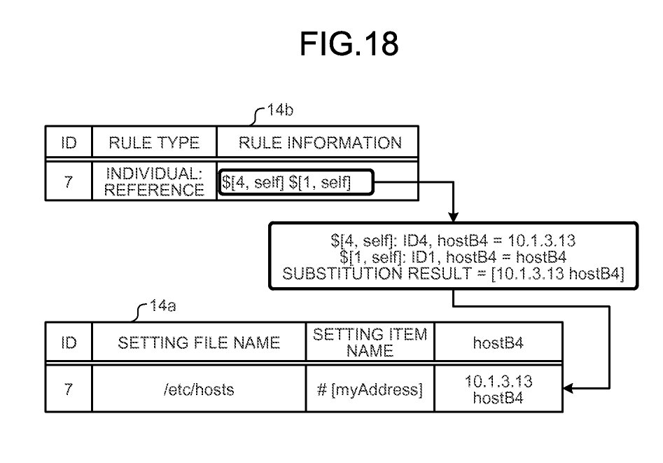

If the rule type of the selected setting item is “individual:reference”, the creating unit 15c acquires, from the rule classification table 14b, the information indicating the reference target that is associated with the selected setting item. FIG. 18 is a schematic diagram illustrating an example of a process performed by the management device according to the first embodiment. FIG. 18 illustrates an example of a part of the rule classification table 14b and an example of a part of the setting information 14a. Furthermore, FIG. 18 schematically illustrates a case in which setting information related to the server 21g is set in the setting information 14a on the basis of the rule classification table 14b. The example illustrated in FIG. 18 indicates a case in which the creating unit 15c acquires the reference target “$[4,self]$[1,self]” from the rule classification table 14b. Then, by using the information indicating the acquired reference target, the creating unit 15c acquires the setting content of the reference target from the setting information 14a. The example illustrated in FIG. 18 indicates a case in which the creating unit 15c acquires, from the setting information 14a by using the reference target of “$[4,self]$[1,self]”, the setting content “10.1.3.13” related to the server 21g with the host name of “hostB4” in the record with the ID of “4”. Furthermore, the example illustrated in FIG. 18 indicates a case in which the creating unit 15c acquires, from the setting information 14a by using the reference target of “$[4,self]$[1,self]”, the setting content of “hostB4” related to the server 21g with the host name of “hostB4” in the record with the ID of “1”. Then, the creating unit 15c sets the acquired setting content in the corresponding item in the setting information 14a. The example illustrated in FIG. 18 indicates a case in which the creating unit 15c sets “10.1.3.13 hostB4” in the item of the server 21g in the record with the ID of “7”.

The creating unit 15c repeatedly performs the process described above until all setting items of the server 21g related to “individual:simple increase”, “individual:reference”, and “individual” have been selected.

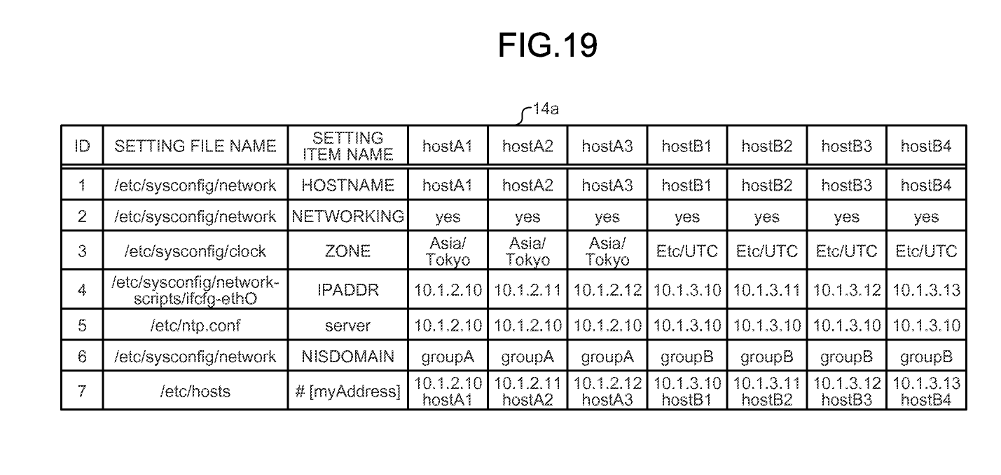

FIG. 19 is a schematic diagram illustrating an example of setting information in which setting content of a new server is set by the management device according to the first embodiment. FIG. 19 illustrates a case in which a piece of setting content is in each setting item of the server 21g.

The setting control unit 15d reads the setting content of the specified device from the setting information 14a and delivers the read setting content to the specified device. Consequently, the delivered setting content is set in the device to which the setting content is delivered.

As described above, with the management device 10 according to the embodiment, because a rule that is used when setting information that is set in the server 21g is created by a process, the setting information on a device can be easily managed when compared with a case in which a person creates a rule. Furthermore, an amount of the process that extracts a setting target having the same setting content can be reduced. Furthermore, with the management device 10, because the rule is created on the basis of the setting information acquired from the existing servers 21a to 21f, the rule can be created in a precise manner from an actual environment in which the existing servers 21a to 21f are stably running.

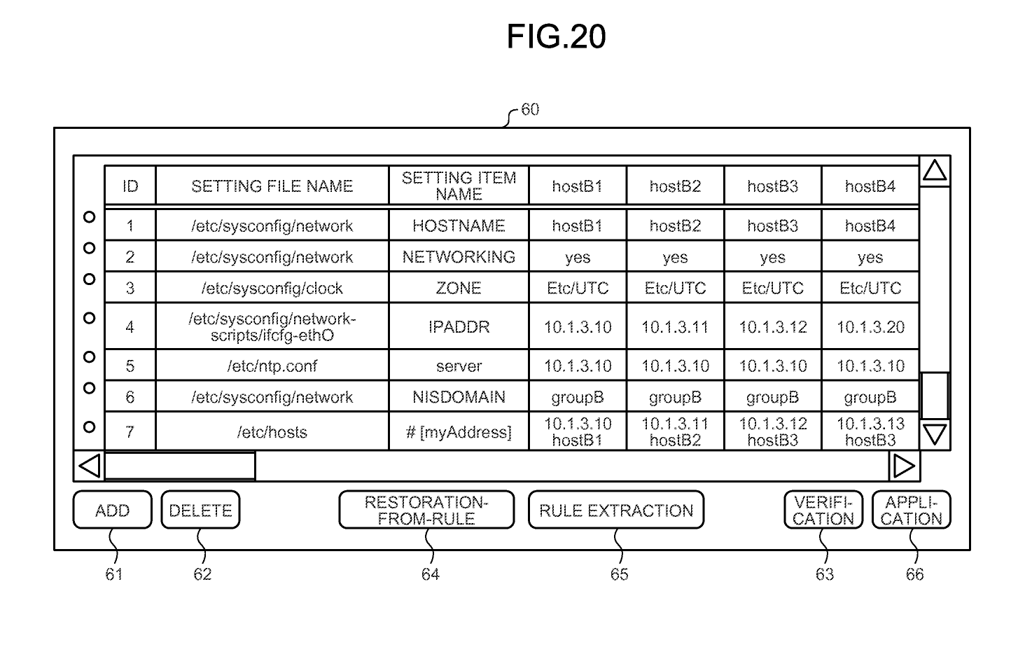

The editing unit 15e displays, on the displaying unit 12, a screen on which the setting information 14a or the rule classification table 14b can be edited by, for example, an administrator. FIG. 20 is a schematic diagram illustrating an example of a screen displayed on a displaying unit according to the first embodiment. The example illustrated in FIG. 20 indicates a case in which the editing unit 15e reads the setting information 14a from the storing unit 14 and displays, on the displaying unit 12, a screen 60 on which the read setting information 14a can be edited. On the screen 60 illustrated as an example in FIG. 20, the content of the setting information 14a is displayed and the setting content of each setting item of each server can be edited by, for example, an administrator via the input unit 11. The example illustrated in FIG. 20 indicates a case in which the setting content of the server 21g with the host name of “hostB4” in the record with the ID of “4” edited from “10.1.3.13” to “10.1.3.20” by an administrator.

Furthermore, the example illustrated in FIG. 20 indicates a case in which an add button 61 that is used to register a new record is displayed on the screen 60. Furthermore, the example illustrated in FIG. 20 indicates a case in which a delete button 62 that is used to delete a record is displayed on the screen 60. Furthermore, in the example illustrated in FIG. 20, a verification button 63, which is used to verify whether the edited setting content of the setting information 14a matches the rule that is indicated by the rule classification table 14b, is displayed on the screen 60. Furthermore, in the example illustrated in FIG. 20, after the verification has been performed, a “restoration-from-rule” button 64, which is used to restore the edited setting content in accordance with the rule that is indicated by the rule classification table 14b, is displayed on the screen 60. Furthermore, in the example illustrated in FIG. 20, after the verification has been performed, a rule extraction button 65, which is used to extract a new rule on the basis of the edited setting content, is displayed on the screen 60. Furthermore, in the example illustrated in FIG. 20, an application button 66, which is used to apply edited setting content, restored setting content, a newly extracted rule, or the like, is displayed on the screen 60.

The verification unit 15f performs verification. For example, when the verification button 63 is pressed, the verification unit 15f acquires the record related to the edited setting content; uses the ID included in the acquired record as a key; and acquires, from the rule classification table 14b, a rule type that is associated with the setting item of the acquired record. If the acquired rule type is “all common”, the verification unit 15f determines whether all of the setting content of the devices in the acquired record is the same. If it is determined that all of the setting content of the devices in the acquired record is the same, the verification unit 15f displays, on the displaying unit 12, a message indicating that the editing content conforms to the existing rule. In contrast, not all of the setting content of the devices is the same, the verification unit 15f displays, on the displaying unit 12, a message indicating that the editing content does not conform to the existing rule.

Furthermore, if the acquired rule type is “group common” or “group common:reference”, the verification unit 15f determines whether the setting content of the devices in the acquired record is the same in a group. If the setting content is the same in the group, the verification unit 15f displays, on the displaying unit 12, a message indicating that the editing content conforms to the existing rule. In contrast, if the group setting content is not the same in the group, the verification unit 15f displays, on the displaying unit 12, a message indicating that the editing content does not conform to the existing rule.

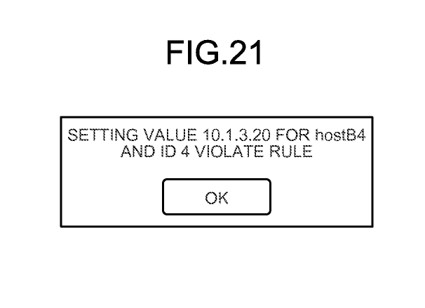

Furthermore, if the acquired rule type is “individual:simple increase”, the verification unit 15f determines whether the setting content of the devices in the acquired record starts from the “initial value” indicated in the rule classification table 14b and increases up to the “maximum value” in an “increment”. If the setting content of the devices in the acquired record starts from the “initial value” indicated in the rule classification table 14b and increases up to the “maximum value” in an “increment”, the verification unit 15f displays, on the displaying unit 12, a message indicating that the editing content conforms to the existing rule. In contrast, if the setting content starts from the “initial value” indicated in the rule classification table 14b and does not increase up to the “maximum value” in an “increment”, the verification unit 15f displays, on the displaying unit 12, a message indicating that the editing content does not conform to the existing rule. In the example illustrated in FIG. 20, the rule type of the setting item indicated by the record with the ID of “4” is “individual:simple increase”; the setting content starts from 10.1.3.10; and the setting content increases up to the maximum value 10.1.3.12 in increments of “1”. However, in the example illustrated in FIG. 20, the maximum value is 10.1.3.20, which violates the rule. FIG. 21 is a schematic diagram illustrating an example of a displayed message indicating that editing content does not conform to the existing rule. The example illustrated in FIG. 21 indicates a case in which the message indicating that “the setting content 10.1.3.20 related to the hostB4 and the ID 4 violates the rule” is displayed. In the example illustrated in FIG. 21, if an OK button is pressed, the message closes.

Furthermore, if the acquired rule type is “individual:reference”, the verification unit 15f determines whether the setting content of the devices in the acquired record is the setting content that is indicated by the reference target. If the setting content is indicated by the reference target, the verification unit 15f displays, on the displaying unit 12, a message indicating that the editing content conforms to the existing rule. In contrast, if the setting content is not indicated by the reference target, the verification unit 15f displays, on the displaying unit 12, a message indicating that the editing content does not conform to the existing rule.

Furthermore, if the acquired rule type is “individual”, the verification unit 15f determines, from among the setting content of the devices in the acquired record, whether the edited setting content matches the other setting content. If the setting content does not match, the verification unit 15f displays, on the displaying unit 12, a message indicating that the editing content conforms to the existing rule. In contrast, the setting content matches, the verification unit 15f displays, on the displaying unit 12, a message indicating that the editing content does not conform to the existing rule.

As described above, the management device 10 according to the embodiment determines whether the edited setting content violates the rule that is obtained by a process. Consequently, with the management device 10 according to the embodiment, verification can be more easily performed.

If the “restoration-from-rule” button 64 is pressed, the verification unit 15f restores the edited setting content in the acquired record in accordance with the content of the rule in the rule classification table 14b. Furthermore, if the rule extraction button 65 is pressed, the verification unit 15f extracts the rule type of the acquired record or the like, similarly to the process performed by the extracting unit 15b or the creating unit 15c described above. Furthermore, if the application button 66 is pressed, the verification unit 15f updates various kinds of information. For example, the verification unit 15f updates the edited setting content in the setting information 14a. Furthermore, the verification unit 15f updates the restored setting content in the setting information 14a. Furthermore, the verification unit 15f updates the extracted rule type in the rule classification table 14b.

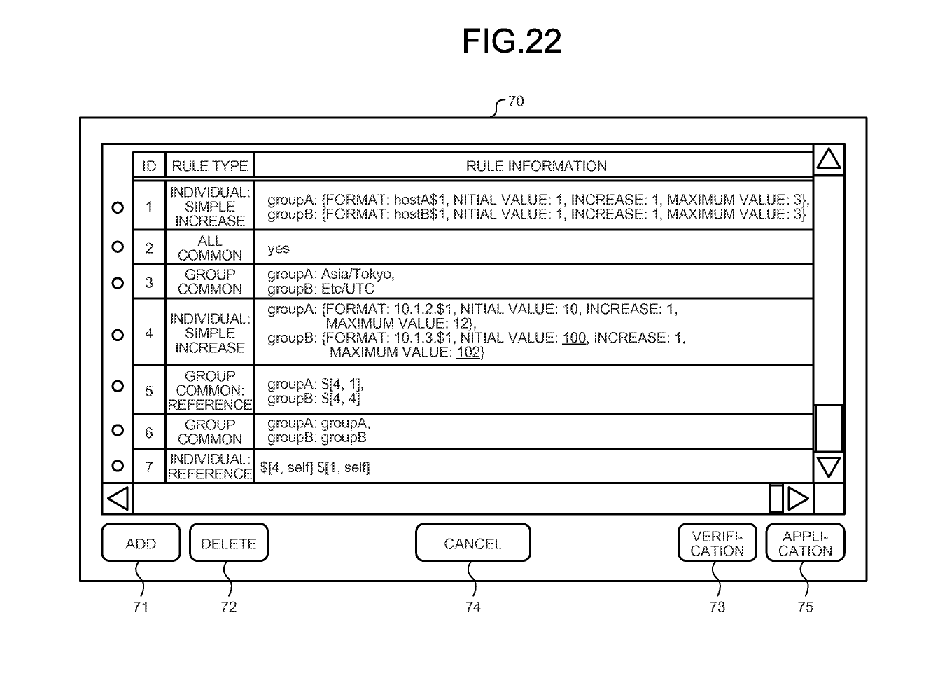

FIG. 22 is a schematic diagram illustrating an example of another screen displayed on a displaying unit according to the first embodiment. The example illustrated in FIG. 22 indicates a case in which the editing unit 15e reads the rule classification table 14b from the storing unit 14 and displays, on the displaying unit 12, a screen 70 on which the read rule classification table 14b can be edited. On the screen 70 illustrated in FIG. 22 as an example, the content of the rule classification table 14b is displayed and the rule information on each of the setting items can be edited by an administrator or the like can be edited via the input unit 11. The example illustrated in FIG. 22 indicates a case in which, for the rule information on the ID of “4”, an administrator edits the initial value “10” and the maximum value “12” to the initial value “100” and the maximum value “102”, respectively.

Furthermore, in the example illustrated in FIG. 22, an add button 71 that is used to register a new record on the screen 70. Furthermore, in the example illustrated in FIG. 22, a delete button 72 that is used to delete a record is displayed on the screen 70. Furthermore, in the example illustrated in FIG. 20, a verification button 73 that is used to verify whether the setting content indicated by the setting information 14a matches the rule in the edited rule classification table 14b is displayed on the screen 70. Furthermore, in the example illustrated in FIG. 22, after the verification has been performed, a CANCEL button 74 that is used to close the screen 70 without updating the edited rule information in the rule classification table 14b is displayed on the screen 70. Furthermore, in the example illustrated in FIG. 22, an application button 75 that is used to apply the edited rule information is displayed on the screen 70.

In the example illustrated in FIG. 22, when the verification button 73 is pressed, the verification unit 15f acquires the record related to the edited rule information and acquires, from the setting information 14a by using the ID included in the acquired record as the key, the setting content that is associated with the setting item in the acquired record. If the rule type of the acquired record is “all common”, the verification unit 15f determines whether all of the setting content of the devices is the same. If all of the setting content of the devices is the same, the verification unit 15f displays, on the displaying unit 12, a message indicating that the setting content conforms to the edited rule. In contrast, if not all of the setting content of the devices is the same, the verification unit 15f displays, on the displaying unit 12, a message indicating that the setting content does not conform to the edited rule.

Furthermore, if the rule type of the acquired record is “group common” or “group common:reference”, the verification unit 15f determines whether the obtained setting content is the same in a group. If the setting content is the same in the group, the verification unit 15f displays, on the displaying unit 12, a message indicating that the setting content conforms to the edited rule. In contrast, if the setting content is not the same in the group, the verification unit 15f displays, on the displaying unit 12, a message indicating that the setting content does not conform to the edited rule.

Furthermore, if the acquired rule type is “individual:simple increase”, the verification unit 15f determines whether the acquired setting content starts from the “initial value” indicated by the rule information in the acquired record and increases up to the “maximum value” in an “increment”. If the acquired setting content starts from the “initial value” indicated by the rule information and increases up to the “maximum value” in an “increment”, the verification unit 15f displays, on the displaying unit 12, a message indicating that the setting content conforms to the edited rule. In contrast, if the acquired setting content starts from the “initial value” indicated by the rule information and does not increase up to the “maximum value” in an “increment”, the verification unit 15f displays, on the displaying unit 12, a message indicating that the setting content does not conform to the edited rule. In the example illustrated in FIG. 22, in the setting item with the ID of “4” indicated by the setting information 14a, the setting content that starts from the initial value of “10” and that increases up to the maximum value of “12” in increments of “1” is registered. However, in the example illustrated in FIG. 22, because the initial value is “100” and the maximum value is “102”, the setting content violates the edited rule. Consequently, in the example illustrated in FIG. 22, when the verification button 73 is pressed, an error screen is displayed.

Furthermore, if the acquired rule type is “individual:reference”, the verification unit 15f determines whether the acquired setting content is the setting content indicated by the reference target. If the acquired setting content is the setting content indicated by the reference target, the verification unit 15f displays, on the displaying unit 12, a message indicating that the setting content conforms to the edited rule. In contrast, if the acquired setting content is not the setting content indicated by the reference target, the verification unit 15f displays, on the displaying unit 12, a message indicating that the setting content does not conform to the edited rule.

Furthermore, if the acquired rule type is “individual”, the verification unit 15f determines whether the acquired setting content matches the edited condition indicated by the rule information. If the acquired setting content matches the edited condition indicated by the rule information, the verification unit 15f displays, on the displaying unit 12, a message indicating that the setting content conforms to the edited rule. In contrast, if the acquired setting content does not match the edited condition indicated by the rule information, the verification unit 15f displays, on the displaying unit 12, a message indicating that the setting content does not conform to the edited rule.

As described above, the management device 10 according to the embodiment determines whether the setting content violates the edited rule that is obtained by the process. Consequently, with the management device 10 according to the embodiment, verification can be more easily performed.

Then, if the CANCEL button 74 is pressed, the verification unit 15f closes the screen 70 without updating the edited rule information in the rule classification table 14b. Furthermore, if the application button 75 is pressed, the verification unit 15f updates the edited rule information in the rule classification table 14b.

The control unit 15 is an integrated circuit, such as an application specific integrated circuit (ASIC), a field programmable gate array (FPGA), and the like, or an electronic circuit, such as a central processing unit (CPU), a micro processing unit (MPU), and the like.

Flow of a Process

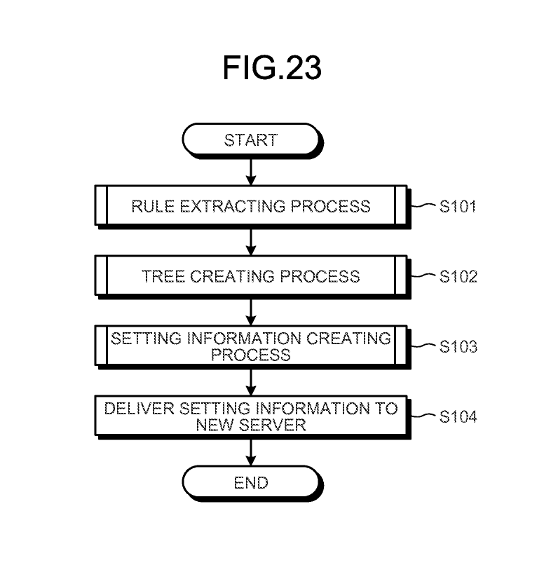

In the following, the flow of a process performed by the management device 10 according to the embodiment will be described. FIG. 23 is a flowchart illustrating the flow of a first management process according to the first embodiment. An example of the timing at which the first management process is performed includes the timing at which the control unit 15 receives, from a user via the input unit 11, an instruction to perform the first management process.

As illustrated in FIG. 23, the acquiring unit 15a, the extracting unit 15b, and the creating unit 15c perform a rule extracting process (Step S101). Then, the creating unit 15c performs a tree creating process (Step S102). Then, the creating unit 15c performs a setting information creating process (Step S103). Then, the setting control unit 15d delivers, to the new server 21g, setting information that is newly created in the setting information 14a (Step S104).

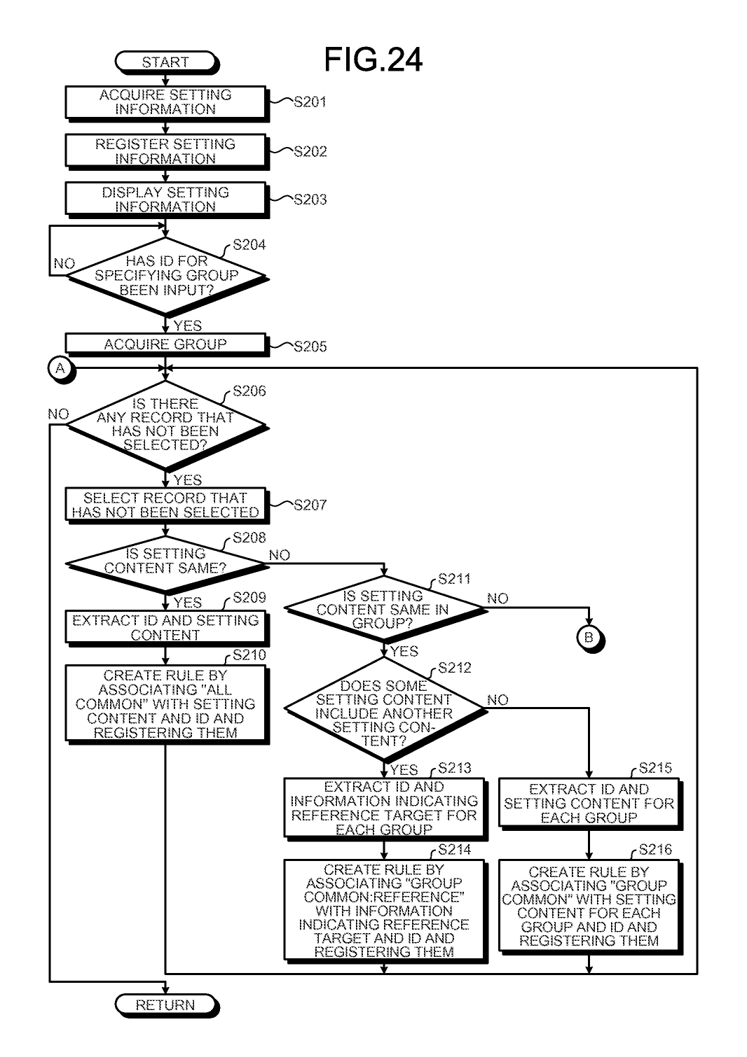

In the following, the rule extracting process will be described. FIG. 24 and are flowcharts each illustrating the flow of the rule extracting process according to the first embodiment.

As illustrated in FIG. 24, the acquiring unit 15a acquires, from the servers 21a to 21f, setting information that indicates a setting item and setting content (Step S201). Then, the acquiring unit 15a registers the setting information on the servers 21a to 21f in the setting information 14a (Step S202). Then, the acquiring unit 15a acquires the setting information 14a from the storing unit 14 and displays the setting information 14a on the displaying unit 12 (Step S203). The acquiring unit 15a determines whether the ID that is used to specify a group is input (Step S204). If the ID is not input (No at Step S204), the acquiring unit 15a performs the same determination again. In contrast, if the ID is input (Yes at Step S204), the acquiring unit 15a acquires the ID that is used to specify a group from the input unit 11 and then acquires the group (Step S205).

The extracting unit 15b determines, from among all of the records registered in the setting information 14a, whether a record that has not been selected is present (Step S206). If no record that has not been selected is present (No at Step S206), the extracting unit 15b stores the result of the process in the internal memory in the control unit 15 and then returns. In contrast, if records that have not been selected are present (Yes at Step S206), the extracting unit 15b selects one record that has not been selected (Step S207). Then, the extracting unit 15b determines whether the setting content of each of the servers 21a to 21f registered in the selected record is the same (Step S208).

If all of the setting content is the same (Yes at Step S208), the extracting unit 15b extracts the ID and the setting content in the selected record (Step S209). The creating unit 15c associates the rule type of “all common” with the ID and the setting content that are extracted by the extracting unit 15b; registers them in the items of the rule type, the ID, and the rule information in the rule classification table 14b (Step S210); and then returns to Step S206.

In contrast, not all of the setting content is the same (No at Step S208), the extracting unit 15b determines whether the setting content is the same in a group (Step S211). If the setting content is the same in a group (Yes at Step S211), the extracting unit 15b determines whether some of the setting content in the selected record includes another setting content (Step S212). If some of the setting content in the selected record includes another setting content (Yes at Step S212), the extracting unit 15b extracts the ID of the selected record and extracts information that indicates the reference target for each group (Step S213). The creating unit 15c associates the rule type of “group common:reference” with the ID and the information that indicates the reference target for each group that are extracted by the extracting unit 15b and then registers them in the items of the rule type, the ID, and the rule information in the rule classification table 14b (Step S214). Then, the process returns to Step S206.

In contrast, if some of the setting content in the selected record does not include another setting content (No at Step S212), the extracting unit 15b extracts the ID of the selected record and setting content for each group (Step S215). The creating unit 15c associates the rule type of “group common” with the ID and the setting content for each group that are extracted by the extracting unit 15b and then registers them in the items of the rule type, the ID, and the rule information in the rule classification table 14b (Step S216). Then, the process returns to Step S206.

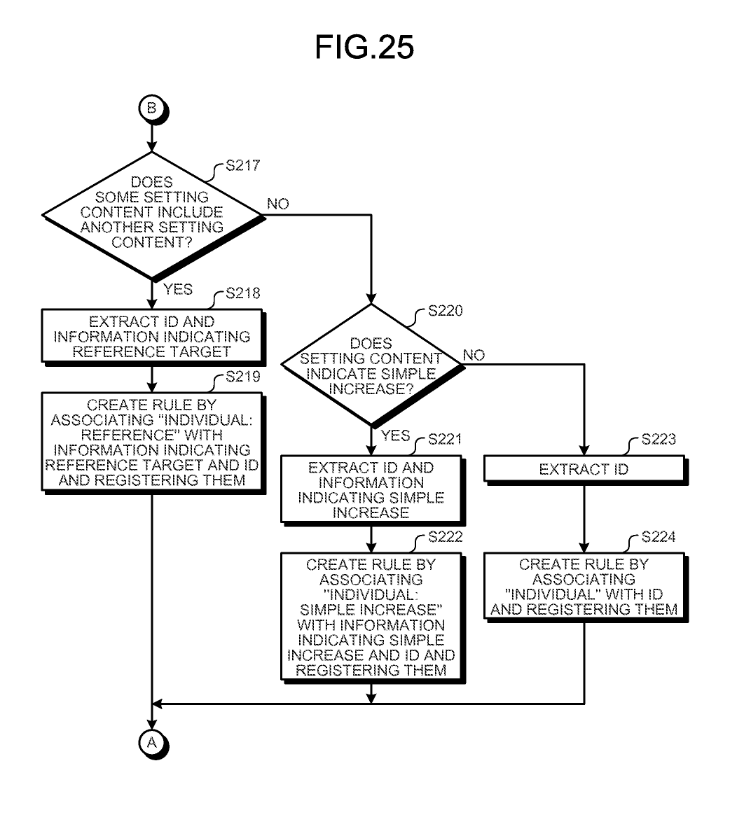

Furthermore, if the setting content is the same in a group (No at Step S211), as illustrated in FIG. 25, the extracting unit 15b determines whether some of the setting content in the selected record includes another setting content (Step S217). If some of the setting content in the selected record includes another setting content (Yes at Step S217), the extracting unit 15b extracts the ID of the selected record and extracts the information that indicates the reference target (Step S218). The creating unit 15c associates the rule type of “individual:reference” with the ID and the information that indicates the reference target that are extracted by the extracting unit 15b and then registers them in the items of the rule type, the ID, and the rule information in the rule classification table 14b (Step S219). Then, the process returns to Step S206.

In contrast, some of the setting content in the selected record does not include another setting content (No at Step S217), the extracting unit 15b determines whether the setting content has the predetermined regularity (Step S220). If the setting content has the predetermined regularity (Yes at Step S220), the extracting unit 15b extracts the ID of the selected record and extracts the information that indicates the simple increase regularity for each server (Step S221). The creating unit 15c associates the rule type of “individual:simple increase” with the ID and the information that indicates the regularity that are extracted by the extracting unit 15b and then registers them in the items of the rule type, the ID, and the rule information in the rule classification table 14b (Step S222). Then, the process returns to Step S206.

If the setting content does not have the predetermined regularity the predetermined regularity (No at Step S220), the extracting unit 15b extracts the ID of the selected record (Step S223). The creating unit 15c associates the rule type of “individual” with the ID that is extracted by the extracting unit 15b and then registers them in the items of the rule type and the ID in the rule classification table 14b (Step S224). Then, the process returns to Step S206.

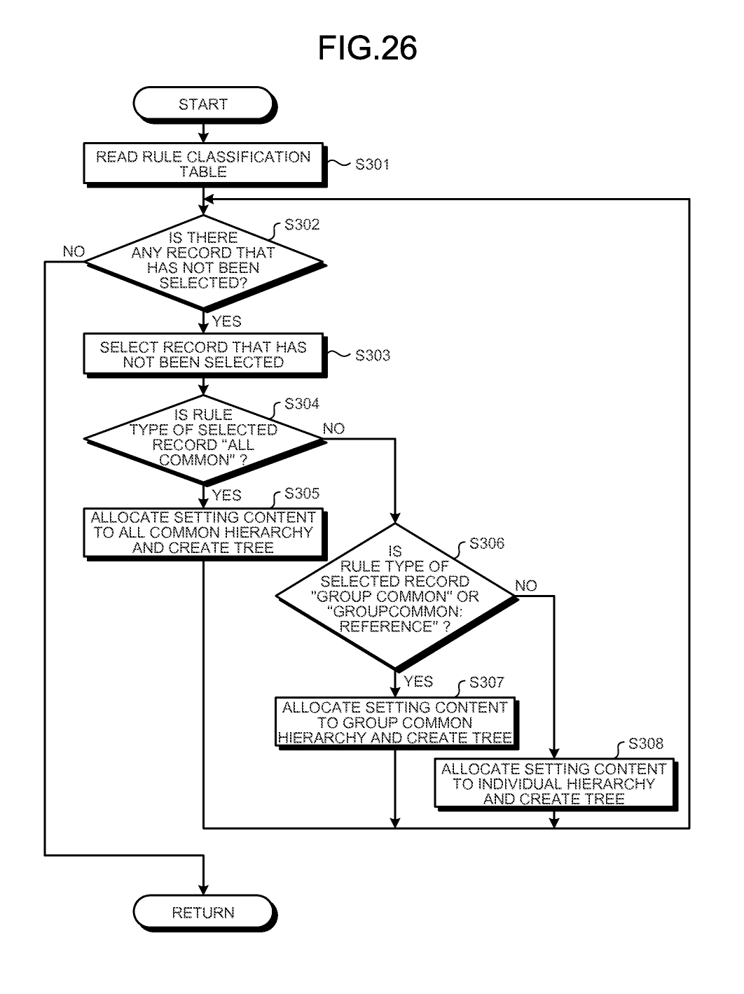

In the following, the tree creating process will be described. FIG. 26 is a flowchart illustrating the flow of the tree creating process according to the first embodiment.

As illustrated in FIG. 26, the creating unit 15c reads the rule classification table 14b from the storing unit 14 (Step S301). Then, the creating unit 15c determines whether a record that has not been selected from among the records is present in the rule classification table 14b (Step S302). If no record that has not been selected is present (No at Step S302), the creating unit 15c stores the result of the process in the internal memory in the control unit 15 and then returns. In contrast, if records that have not been selected are present (Yes at Step S302), the creating unit 15c selects one record that has not been selected (Step S303). Then, the creating unit 15c determines whether the rule type of the selected record is “all common” (Step S304). If the rule type of the selected record is “all common” (Yes at Step S304), the creating unit 15c searches the setting information 14a for a record with the same ID number as that of the selected record. Then, the creating unit 15c allocates the setting content indicated by the record that is obtained from the searched result to the hierarchy named “all common” in the tree 14c (Step S305) and then returns to Step S302.

In contrast, the rule type of the selected record is not “all common” (No at Step S304), the creating unit 15c determines whether the rule type of the selected record is “group common” or “group common:reference” (Step S306). If the rule type of the selected record is “group common” or “group common:reference” (Yes at Step S306), the creating unit 15c searches the setting information 14a for a record with the same ID number as that of the selected record. Then, the creating unit 15c allocates the setting content indicated by the record that is obtained from the searched result to the hierarchy named group common in the tree 14c (Step S307) and then returns to Step S302.

If the rule type of the selected record is neither “group common” nor “group common:reference” (No at Step S306), the creating unit 15c searches the setting information 14a for a record with the same ID number as that of the selected record. Then, the creating unit 15c allocates the setting content indicated by the record that is obtained from the searched result to the hierarchy named individual in the tree 14c (Step S308) and then returns to Step S302.

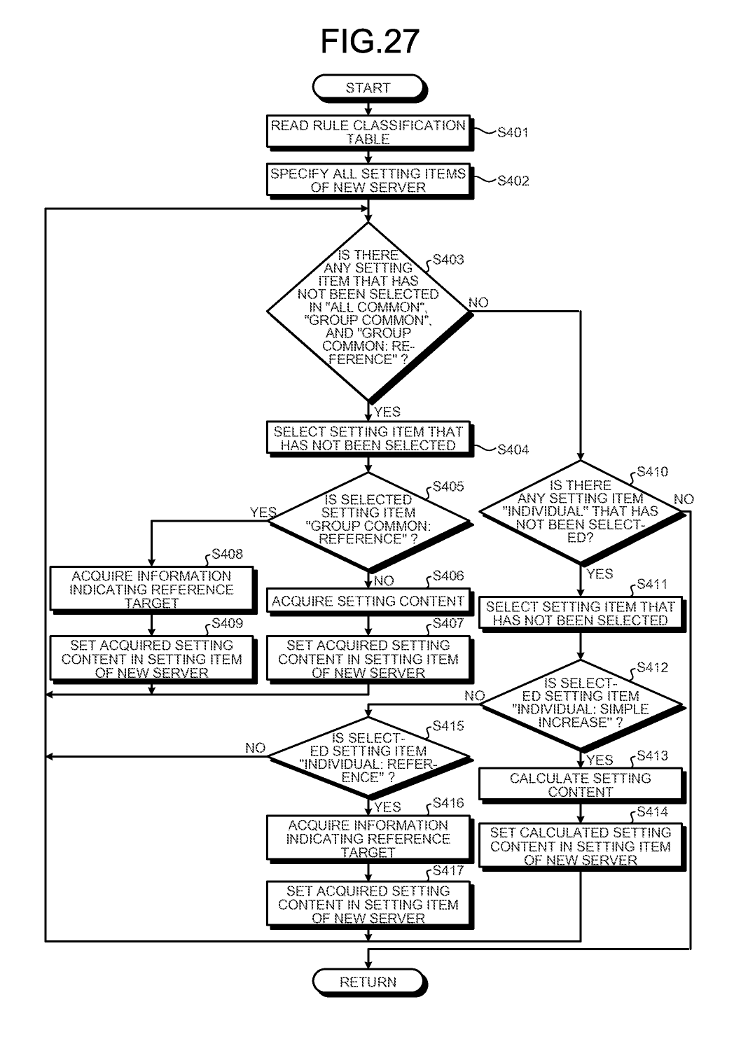

In the following, the setting information creating process will be described. FIG. 27 is a flowchart illustrating the flow of the setting information creating process according to the first embodiment.

As illustrated in FIG. 27, the creating unit 15c reads the rule classification table 14b and the tree 14c from the storing unit 14 (Step S401). Then, the creating unit 15c specifies the setting item of the server 21g (Step S402). Subsequently, from among the setting items of the server 21g with the rule type of “all common”, “group common”, and “group common:reference” in the rule classification table 14b, the creating unit 15c determines whether a setting item that has not been selected is present (Step S403). If a setting item that has not been selected is present (Yes at Step S403), the creating unit 15c selects the setting item that has not been selected (Step S404). Then, the creating unit 15c determines whether the rule type of the selected setting item is “group common:reference” (Step S405).

If the rule type of the selected setting item is “group common:reference” (Yes at Step S405), the creating unit 15c acquires, from the rule classification table 14b, the information indicating the reference target that is associated with the selected setting item (Step S408). Then, by using the information that indicates the acquired reference target, the creating unit 15c acquires the setting content of the reference target from the setting information 14a, sets the acquired setting content in the corresponding item in the setting information 14a (Step S409), and then returns to Step S403.

Furthermore, if the rule type of the selected setting item is not “group common:reference” (No at Step S405), the creating unit 15c acquires the setting content associated with the selected setting item from the rule information in the rule classification table 14b (Step S406). Then, the creating unit 15c sets the acquired setting content in the corresponding item in the setting information 14a (Step S407). Then, the creating unit 15c returns to Step S403.

Furthermore, from among the setting items of the server 21g with the rule type of “individual:simple increase”, “individual:reference”, and “individual”, the creating unit 15c determines whether a setting item that has not been selected is present (Step S410). If a setting item that has not been selected is present (Yes at Step S410), the creating unit 15c selects a setting item that has not been selected (Step S411). Then, the creating unit 15c determines whether the rule type of the selected setting item is “individual:simple increase” (Step S412).

If the rule type of the selected setting item is “individual:simple increase” (Yes at Step S412), the creating unit 15c acquires the information indicating the regularity that is associated with the selected setting item from the rule classification table 14b and then calculates setting content by using the information that indicates the acquired regularity (Step S413).

Then, the creating unit 15c sets the calculated setting content in the corresponding item in the setting information 14a (Step S414) and then returns to Step S403.

In contrast, if the rule type of the selected setting item is not “individual:simple increase” (No at Step S412), the creating unit 15c determines whether the rule type of the selected setting item is “individual:reference” (Step S415).

If the rule type of the selected setting item is not “individual:reference” (No at S415), the creating unit 15c stores the result of the process in the internal memory in the control unit 15 and then returns. In contrast, if the rule type of the selected setting item is “individual:reference” (Yes at Step S415), the creating unit 15c acquires, from the rule classification table 14b, the information indicating the reference target that is associated with the selected setting item (Step S416). Then, the creating unit 15c sets the acquired setting content in the corresponding item in the setting information 14a (Step S417) and then returns to Step S403.

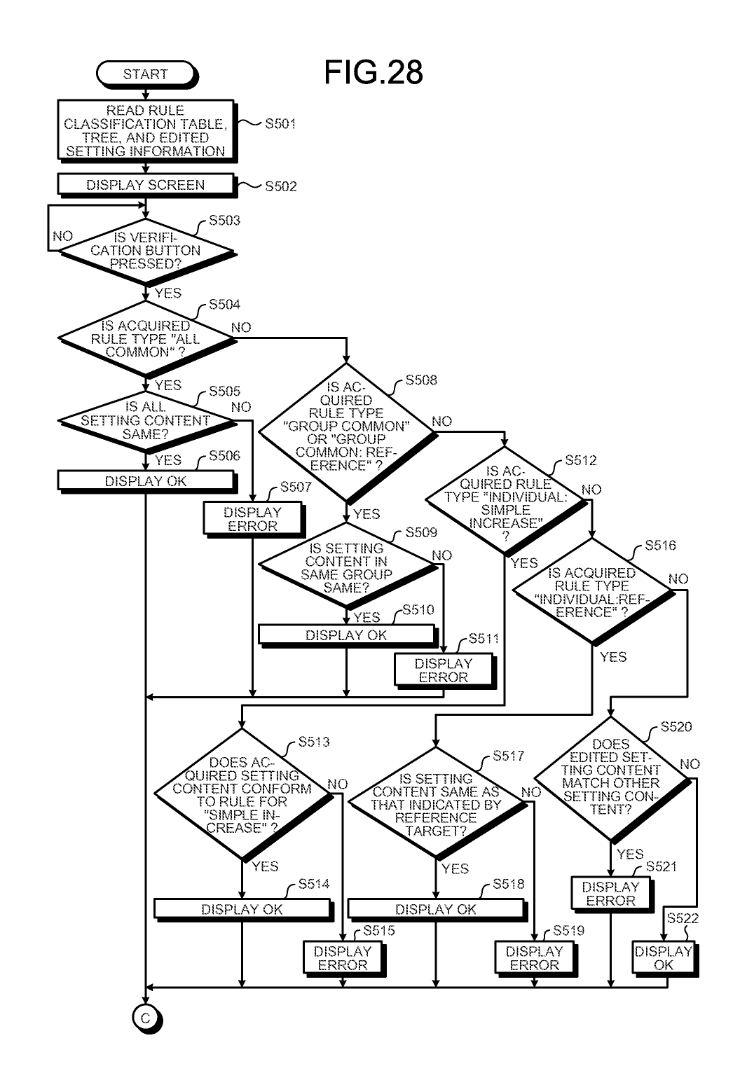

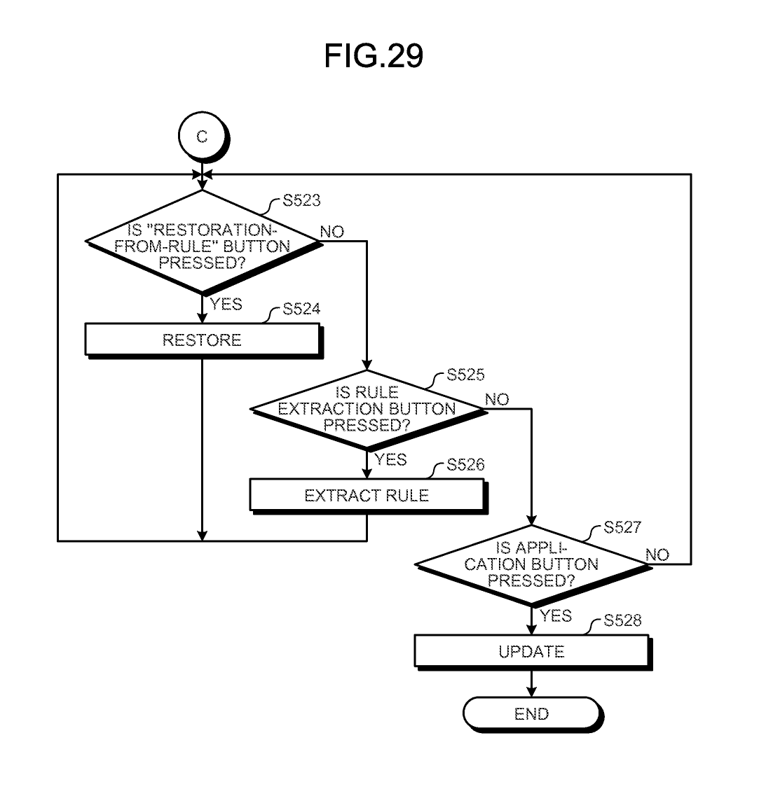

FIGS. 28 and 29 are flowcharts each illustrating the flow of the second management process according to the first embodiment. An example of the timing at which the second management process is performed includes the timing at which the control unit 15 receives, from a user via the input unit 11, an instruction to perform the second management process.

As illustrated in FIG. 26, the editing unit 15e displays a screen on which the setting information 14a can be edited and then acquires the rule classification table 14b, the tree 14c, and the setting information 14a that has been changed (Step S501). The editing unit 15e displays, on the displaying unit 12, a screen that prompts to press the verification button (Step S502).

The verification unit 15f determines whether the verification button is pressed (Step S503). When the verification button is pressed (Yes at Step S503), the verification unit 15f acquires the rule type that is associated with the setting item of the acquired record from the rule classification table 14b by using the ID included in the record related to the edited setting content as a key. Then, the verification unit 15f determines whether the acquired rule type is “all common” (Step S504). If the acquired rule type is “all common” (Yes at Step S504), the verification unit 15f determines whether all of the setting content of the device in the acquired record is the same (Step S505).

If all of the setting content of the device in the acquired record is the same (Yes at Step S505), the verification unit 15f displays, on the displaying unit 12, a message indicating that the editing content conforms to the existing rule (Step S506). In contrast, if not all of the setting content of the device in the acquired record is the same (No at Step S505), the verification unit 15f displays, on the displaying unit 12, a message indicating that the editing content does not conform to the existing rule (Step S507) and then proceeds to Step S523.

In contrast, if the acquired rule type is not “all common” (No at Step S504), the verification unit 15f determines whether the acquired rule type is “group common” or “group common:reference” (Step S508). If the acquired rule type is “group common” or “group common:reference” (Yes at S508), the verification unit 15f determines whether the setting content of the device in the acquired record is the same in a group (Step S509). If the setting content in the acquired record is the same in a group (Yes at Step S509), the verification unit 15f displays, on the displaying unit 12, a message indicating that the editing content conforms to the existing rule (Step S510). In contrast, if the setting content in the acquired record is not the same in a group (No at Step S509), the verification unit 15f displays, on the displaying unit 12, a message indicating that the editing content does not conform to the existing rule (Step S511) and then proceeds to Step S523.

In contrast, if the acquired rule type is neither “group common” nor “group common:reference” (No at Step S508), the verification unit 15f determines whether the acquired rule type is “individual:simple increase” (Step S512). If the acquired rule type is “individual:simple increase” (Yes at Step S512), the verification unit 15f determines whether the acquired setting content of the acquired record starts from the “initial value” indicated in the rule classification table 14b and increases up to the “maximum value” in an “increment” (Step S513). If the acquired setting content starts from the “initial value” indicated in the rule classification table 14b and increases up to the “maximum value” in an “increment” (Yes at Step S513), the verification unit 15f displays, on the displaying unit 12, a message indicating that the editing content conforms to the edited rule (Step S514). In contrast, if the acquired setting content starts from the “initial value” indicated in the rule classification table 14b and does not increase up to the “maximum value” in an “increment” (No at Step S513), the verification unit 15f displays, on the displaying unit 12, a message indicating that the editing content does not conform to the existing rule (Step S515) and then proceeds to Step S523.

Furthermore, if the acquired rule type is not “individual:simple increase” (No at Step S512), the verification unit 15f determines whether the acquired rule type is “individual:reference” (Step S516). If the acquired rule type is “individual:reference” (Yes at S516), the verification unit 15f determines whether the setting content of the device in the acquired record is the setting content indicated by the reference target (Step S517). If the setting content of the device in the acquired record is the setting content indicated by the reference target (Yes at Step S517), the verification unit 15f displays, on the displaying unit 12, a message indicating that the editing content conforms to the existing rule (Step S518). In contrast, if the setting content of the device in the acquired record is not the setting content indicated by the reference target (No at Step S517), the verification unit 15f displays, on the displaying unit 12, a message indicating that the editing content does not conform to the existing rule (Step S519).

Furthermore, if the acquired rule type is not “individual:reference” (No at Step S516), the verification unit 15f determines, from among the setting content of the devices in the acquired record, whether the edited setting content matches the other setting content (Step S520). If the edited setting content does not match the other setting content (No at Step S520), the verification unit 15f displays, on the displaying unit 12, a message indicating that the editing content conforms to the existing rule (Step S522). In contrast, if the edited setting content matches the other setting content (Yes at Step S520), the verification unit 15f displays, on the displaying unit 12, a message indicating that the editing content does not conform to the existing rule (Step S521) and then proceeds to Step S523.

Then, the verification unit 15f determines whether the “restoration-from-rule” button is pressed (Step S523). If the “restoration-from-rule” button is pressed (Yes at Step S523), the verification unit 15f restores the edited setting content in the acquired record in accordance with the content of the rule in the rule classification table 14b (Step S524) and then returns to Step S523. If the “restoration-from-rule” button is not pressed (No at Step S523), the verification unit 15f determines whether the rule extraction button is pressed (Step S525). If the rule extraction button is pressed (Yes at Step S525), the verification unit 15f extracts the rule type of the acquired record or the like (Step S526) and then returns to Step S523. In contrast, if the rule extraction button is not pressed (No at Step S525), the verification unit 15f determines whether the application button is pressed (Step S527). If the application button is pressed (Yes at Step S527), the verification unit 15f updates various kinds of information (Step S528) and then ends the process. In contrast, if the application button is not pressed (No at Step S527), the verification unit 15f returns to Step S523.

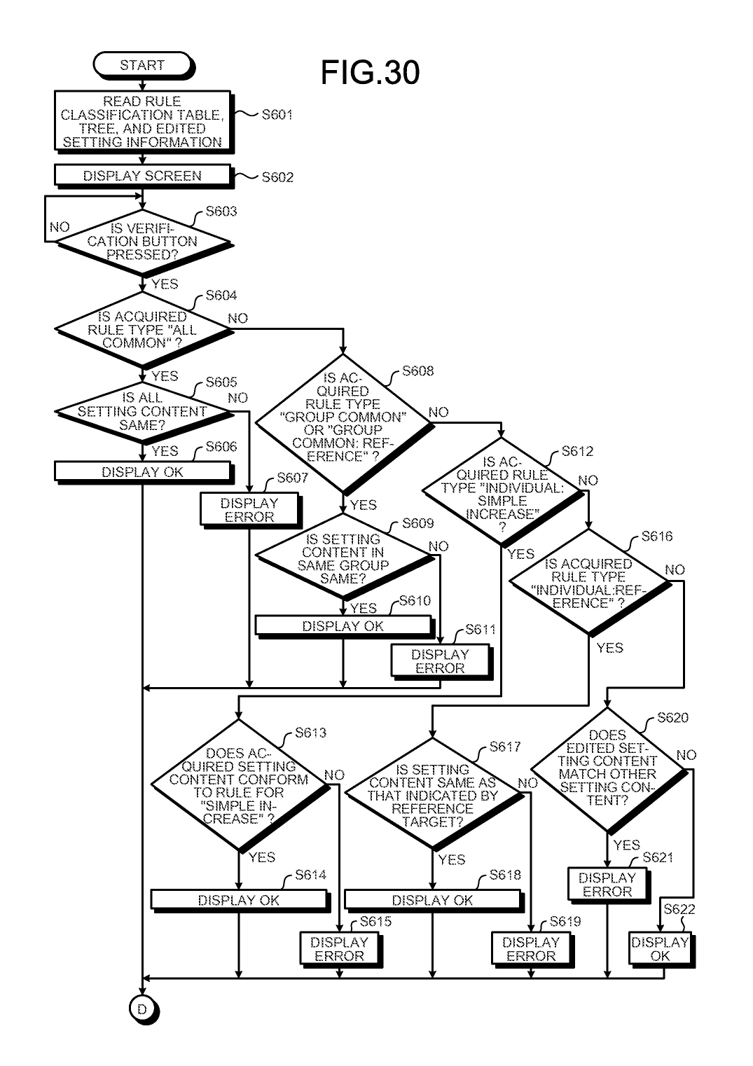

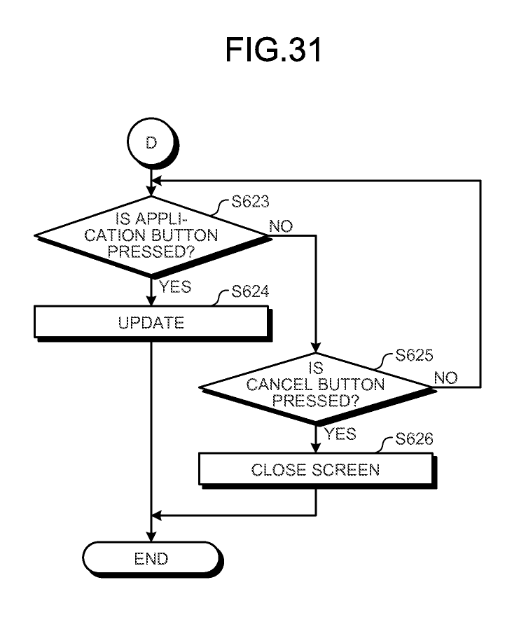

FIGS. 30 and 31 are flowcharts each illustrating the flow of the third management process according to the first embodiment. An example of the timing at which the third management process is performed is the timing at which the control unit 15 receives, from a user via the input unit 11, an instruction to perform the third management process.

As illustrated in FIG. 30, after the editing unit 15e displays a screen on which the rule classification table 14b can be edited, the editing unit 15e acquires the edited rule classification table 14b, the tree 14c, and the setting information 14a (Step S601). The editing unit 15e displays, on the displaying unit 12, a screen that prompts to press the verification button (Step S602).

The verification unit 15f determines whether the verification button is pressed (Step S603). When the verification button is pressed (Yes at Step S603), the verification unit 15f acquires the rule type of the edited rule information. Then, the verification unit 15f determines whether the acquired rule type is “all common” (Step S604). If the acquired rule type is “all common” (Yes at Step S604), the verification unit 15f determines whether all of the setting content of the devices is the same (Step S605).

If all of the setting content of the devices is the same (Yes at Step S605), the verification unit 15f displays, on the displaying unit 12, a message indicating that the setting content conforms to the edited rule (Step S606). In contrast, not all of the setting content of the devices is the same (No at Step S605), the verification unit 15f displays, on the displaying unit 12, a message indicating that the setting content does not conform to the edited rule (Step S607) and then proceeds to Step S623.

In contrast, the acquired rule type is not “all common” (No at Step S604), the verification unit 15f determines whether the acquired rule type is “group common” or “group common:reference” (Step S608). If the acquired rule type is “group common” or “group common:reference” (Yes at Step S608), the verification unit 15f determines whether the acquired setting content is the same in a group (Step S609). If the acquired setting content is the same in a group (Yes at Step S609), the verification unit 15f displays, on the displaying unit 12, a message indicating that the setting content conforms to the edited rule (Step S610). In contrast, if the acquired setting content is not the same in a group (No at Step S609), the verification unit 15f displays, on the displaying unit 12, a message indicating that the setting content does not conform to the edited rule (Step S611) and then proceeds to Step S623.

In contrast, if the acquired rule type is neither “group common” nor “group common:reference” (No at Step S608), the verification unit 15f determines whether the acquired rule type is “individual:simple increase” (Step S612). If the acquired rule type is “individual:simple increase” (Yes at Step S612), the verification unit 15f determines whether the acquired setting content of the acquired record starts from the “initial value” indicated in the rule classification table 14b and increases up to the “maximum value” in an “increment” (Step S613). If the acquired setting content starts from the “initial value” indicated in the rule classification table 14b and increases up to the “maximum value” in an “increment” (Yes at Step S613), the verification unit 15f displays, on the displaying unit 12, a message indicating that the setting content conforms to the edited rule (Step S614). In contrast, if the acquired setting content starts from the “initial value” indicated in the rule classification table 14b and does not increase up to the “maximum value” in an “increment” (No at Step S613), the verification unit 15f displays, on the displaying unit 12, a message indicating that the setting content does not conform to the edited rule (Step S615) and then proceeds to Step S623.

Furthermore, if the acquired rule type is not “individual:simple increase” (No at Step S612), the verification unit 15f determines whether the acquired rule type is “individual:reference” (Step S616). If the acquired rule type is “individual:reference” (Yes at Step S616), the verification unit 15f determines whether the setting content of the device in the acquired record is the setting content indicated by the reference target (Step S617). If the setting content of the device in the acquired record is the setting content indicated by the reference target (Yes at S617), the verification unit 15f displays, on the displaying unit 12, a message indicating that the setting content conforms to the edited rule (Step S618). In contrast, if the setting content of the device in the acquired record is not the setting content indicated by the reference target (No at Step S617), the verification unit 15f displays, on the displaying unit 12, a message indicating that the setting content does not conform to the edited rule (Step S619).

Furthermore, if the acquired rule type is not “individual:reference” (No at Step S616), the verification unit 15f determines whether the acquired setting content matches the edited condition indicated by the rule information (Step S620). If the acquired setting content matches the edited condition indicated by the rule information (Yes at Step S620), the verification unit 15f displays, on the displaying unit 12, a message indicating that the setting content conforms to the edited rule (Step S622). In contrast, if the acquired setting content does not match the edited condition indicated by the rule information (No at Step S620), the verification unit 15f displays, on the displaying unit 12, a message indicating that the setting content does not conform to the edited rule (Step S621) and then proceeds to Step S623.

Then, the verification unit 15f determines whether the application button is pressed (Step S623). If the application button is pressed (Yes at Step S623), the verification unit 15f updates the edited rule information in the rule classification table 14b (Step S624) and then ends the process. In contrast, if the application button is not pressed (No at Step S623), the verification unit 15f determines whether the CANCEL button is pressed (Step S625). If the CANCEL button is pressed (Yes at Step S625), the verification unit 15f closes the screen 70 without updating the edited rule information in the rule classification table 14b (Step S626) and ends the process. In contrast, if the CANCEL button is not pressed (No at Step S625), the verification unit 15f returns to Step S623.

As described above, with the management device 10 according to the embodiment, because the rule that is used to create setting information that is set in the server 21g is created by a process, the setting information on a device can be easily managed when compared with a case in which a person creates a rule. Furthermore, an amount of the process that extracts a setting target having the same setting content can be reduced. Furthermore, with the management device 10, because the rule is created on the basis of the setting information acquired from the existing servers 21a to 21f, the rule can be created in a precise manner from an actual environment in which the existing servers 21a to 21f is stably running.

Furthermore, the management device 10 according to the embodiment determines whether edited setting content violates the rule that is obtained by a process. Consequently, with the management device 10 according to the embodiment, verification can be more easily performed.

In the above explanation, a description has been given of the embodiments of the device according to the present invention; however, the present invention can be implemented with various kinds of embodiments other than the embodiments described above. Therefore, another embodiment included in the present invention will be described below.

For example, in the first embodiment, the description has been given of a case in which the servers are used as devices; however, any devices, such as network devices, storage devices, or the like, may also be used irrespective of whether the devices are physically or virtually used.

Furthermore, of the processes described in the first embodiment, the whole or a part of the processes that are mentioned as being automatically performed can be manually performed. Alternatively, the whole or a part of the processes that are mentioned as being manually performed can be automatically performed using known methods.

Furthermore, the processes performed at steps described in each embodiment may be separated or integrated depending on various loads or use conditions. Furthermore, it may also be possible to omit a step.

Furthermore, the order of the processes performed at steps described in each embodiment may be changed depending on various loads or use conditions. For example, the process at Step S220 may also be performed before the process at Step S217.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the editing unit 15e and the verification unit 15f illustrated in FIG. 2 may also be integrated.

### [b] Second Embodiment

### Management Program

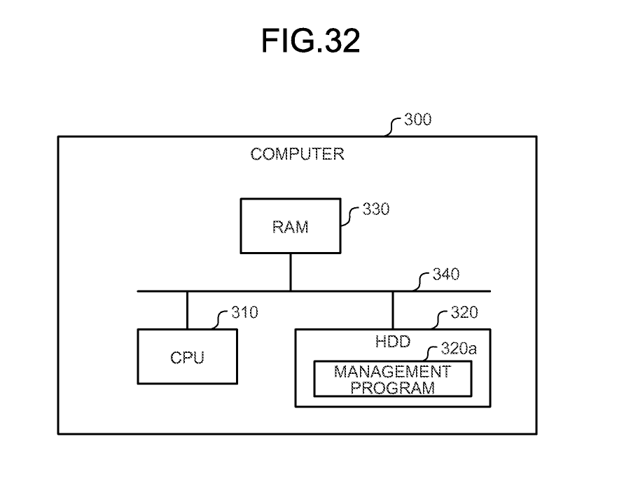

Furthermore, various processes performed by the management device 10 described in the above embodiment may also be implemented by program prepared in advance and executed by a computer system, such as a personal computer or a workstation. Accordingly, in the following, an example of a computer that executes a management program having the same function as that performed by the management device 10 described in the above embodiment will be described with reference to FIG. 32. FIG. 32 is a block diagram illustrating a computer that executes a management program.

As illustrated in FIG. 32, a computer 300 according to a second embodiment includes a central processing unit (CPU) 310, a hard disk drive (HDD) 320, and a random access memory (RAM) 330. Each of the units 310 to 330 is connected via a bus 340.

The HDD 320 stores therein, in advance, a management program 320a having the same function as that performed by the acquiring unit 15a, the extracting unit 15b, the creating unit 15c, the setting control unit 15d, the editing unit 15e, and the verification unit 15f described in the first embodiment. The management program 320a may also be appropriately separated. For example, the management program 320a may also be divided into two: a program having the same function as that performed by the acquiring unit 15a, the extracting unit 15b, the creating unit 15c, and the setting control unit 15d and a program having the same function as that performed by the editing unit 15e and the verification unit 15f.

Then, the CPU 310 reads the management program 320a from the HDD 320 and executes the management program 320a.

The HDD 320 stores therein setting information, a rule classification table, and a tree. The setting information, the rule classification table, and the tree correspond to the setting information 14a, the rule classification table 14b, and the tree 14c, respectively, illustrated in FIG. 1.

Then, the CPU 310 reads the setting information, the rule classification table, and the tree and then stores them in the RAM 330. Furthermore, by using the setting information, the rule classification table, and the tree stored in the RAM 330, the CPU 310 executes the management program 320a. All the data stored in the RAM 330 does not always have to be stored in the RAM 330, and only a part of data, from among all the pieces of data, used for processes may be stored in the RAM 330.

Furthermore, the management program described above does not need to be stored in the HDD 320 from the beginning.

For example, the program is stored in a “portable physical medium”, such as a flexible disk (FD), a CD-ROM, a DVD disk, a magneto-optic disk, an IC CARD, or the like that is to be inserted into the computer 300. Then, the computer 300 may read and execute the program from the portable physical medium.

Furthermore, the program is stored in “another computer (or a server)” or the like that is connected to the computer 300 through a public circuit, the Internet, a LAN, a WAN, or the like. Then, the computer 300 may read the program from the other computer or the server device and execute the program.

According to one aspect of an embodiment of the management device, the management program, and the management method disclosed in the present invention, an amount of the process that extracts a setting target having the same setting content can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device comprising:
a memory; and
a processor coupled to the memory, wherein the processor executes a process comprising:
acquiring, from a plurality of devices, group information indicating a management group used to manage the devices and setting information indicating a setting item and setting content that are set in each of the devices;
extracting a setting item corresponding to setting content that is common to devices included in a same management group indicated by the acquired group information; and
creating, for the extracted setting item, a rule indicating that a common setting content is set to the devices included in the same management group.

2. The management device according to claim 1, wherein
the extracting includes extracting a setting item corresponding to setting content that has predetermined regularity in setting contents of the devices included in the same management group indicated by the acquired group information, and
the creating includes creating, for the extracted setting item, a rule indicating that setting is performed, based on the predetermined regularity, on the devices included in the same management group.

3. The management device according to claim 1, wherein the process further comprises verifying whether the setting content that is set in each of the devices matches the rule.

4. A non-transitory computer-readable recording medium having stored therein a management program causing a computer to execute a process comprising:
acquiring, from a plurality of devices, group information indicating a management group used to manage the devices and setting information indicating a setting item and setting content that are set in each of the devices;
extracting a setting item corresponding to setting content that is common to devices included in a same management group indicated by the acquired group information; and
creating, for the extracted setting item, a rule indicating that a common setting content is set to the devices included in the same management group.

5. A management method comprising:
acquiring, from a plurality of devices, group information indicating a management group used to manage the devices and setting information indicating a setting item and setting content that are set in each of the devices, using a processor;
extracting a setting item corresponding to setting content that is common to devices included in a same management group indicated by the acquired group information, using the processor; and
creating, for the extracted setting item, a rule indicating that a common setting content is set to the devices included in the same management group, using the processor.
